(19) United States
(12) Patent Application Publication
(10) Pub. No.: US 2007/0124627 A1
(43) Pub. Date: May 31, 2007

(54) Communication processing device, home electric device, and home network system

(76) Inventors: Toshiaki Katano, Amagasaki-shi (JP); Yukiko Nagoshi, Moriguchi-shi (JP); Hidetoshi Takubo, Toyonaka-shi (JP)

Correspondence Address: WENDEROTH, LIND & PONACK L.L.P., 2033 K. STREET, NW, SUITE 800, WASHINGTON, DC, 20006, US

(21) Appl. No.: 10/564,813

(22) PCT Filed: Mar. 23, 2005
(86) PCT No.: PCT/JP05/05273

§ 371 Date: Jan. 17, 2006

(30) Foreign Application Priority Data
Mar. 26, 2004 (JP) 2004-091441

(51) Int. Cl. G06F 11/00

(52) U.S. Cl. 714/708

(57) ABSTRACT

A transmission rate negotiation between multi-rate home electric device 100 and communication processing device 200 is completed by sending and receiving a line connection request containing supported transmission rate specifying information specifying plural settable transmission rates, and a device interface information finalization notice containing selected transmission rate information specifying the selected transmission rate once between the home electric device 100 and the communication processing device 200. It is thus possible to shorten a time needed for the communication procedure for the transmission rate negotiation between the home electric device 100 and the communication processing device 200.

### TECHNICAL FIELD

The present invention relates to a communication processing device that links a home electric device to a network, and a home electric device connected to the communication processing device, and a home network system using these devices.

### BACKGROUND ART

Recently, not only a network that needs a data transmission at a high rate and a large capacity, such as videos, but also various services in the form of a network comprising inexpensive facilities at relatively low rate and low capacity and applicable to various so-called white goods and household appliances for use at home have been proposed as an in-home communication infrastructure, that is, the so-called home network.

However, in order to provide a communication processing device to the home electric device, there is a need to develop two types of home electric device: a network-ready home electric device and a stand-alone home electric device. Such a need increases the development costs; moreover, when the user wishes to achieve a home network, all the home electric devices have to be of the network-ready type.

In addition, in a case where the user wishes to link a home electric device that has been installed to a network, a preferable method for installing a home network is to retrofit a communication processing device having a communication processing portion and a transmission medium to the home electric device. When the communication processing device is connected to the home electric device, not a manual setting by the user, but an automatic setting is required.

In the case of multi-rate home electric device and communication processing device, the transmission rate negotiation has to be performed first at the time of connection. In general, a fallback procedure is known for the transmission rate negotiation. The fallback procedure is a method by which the transmission rate is lowered step by step from 9600 bps to 7200 bps to 4800 bps to 2400 bps at one end until a line reply is detected. This procedure can determine a transmission rate in a reliable manner.

For example, as is shown in FIG. 30, a transmission rate selection method described in Patent Document 1 repeats a reconfirmation by lowering the transmission rate when no line reply is detected. More specifically, as signals (1), (3), (5), and (7) of FIG. 30, line connection requests are sent by lowering the transmission rate. The transmission rate negotiation can be thus performed without the need for the user to set the transmission rate.

Also, Patent Document 2 discloses a data transmission device that finds a highest data transfer rate among plural transfer rates by performing a data sending and receiving test at a transfer rate set on the basis of parameters sent from the host station, and by performing the data sending and receiving test again at a higher transfer rate when the data sending and receiving is judged as being enabled up to a transfer rate at which the data sending and receiving is no longer judged as being enabled. The data communication device also re-establishes communications and re-sends communication data by detecting and notifying an error condition resulting from deterioration of a line condition or the like.

Patent Document 1: JP-A-2001-251382

Patent Document 2: JP-A-6-291809

### DISCLOSURE OF THE INVENTION

According to the firstly-mentioned method, however, on the sender's end, a line connection request has to be sent repetitively by exploiting a time-out set for the line connection request while changing the transmission rate until the line connection request is accepted. Hence, this method has a drawback that when plural transmission rates are supported, many transmissions are involved for the negotiation and a communication time needed for the connection becomes longer. Meanwhile, the secondly-mentioned method has the same drawback because data sending and receiving test has to be repeated until data sending and receiving are no longer enabled. In particular, the home electric device is different from a PC (Personal Computer) in that it is not assumed to be in a situation that makes the user wait until the settings are completed. Hence, a shorter negotiation time is more preferable.

Also, home electric devices are installed in various places in the house, and the use condition of each home electric device keeps changing with time. A communication environment between the home electric device and the communication device therefore may possibly keep changing with time. For this reason, transmission rate set before is not necessarily the optimal transmission rate under the current communication environment, and there may be a case where stable communications cannot be made by directly using the transmission rate set before.

An object of the invention is to provide a communication processing device and a home electric device capable of shortening a time needed for a communication procedure during the transmission rate negotiation.

Another object of the invention is to provide a communication processing device and a home electric device capable of setting an optimal transmission rate in accordance with the communication environment.

One aspect of the invention provides a communication processing device that links a home electric device to a network, including: a communication portion that sends/receives data to/from the home electric device; a detection portion that detects a communication error status with the home electric device; a storage portion that stores the communication error status detected by the detection portion; and a setting portion that sets a transmission rate with the home electric device on a basis of a last communication error status stored in the storage portion and a latest communication error status detected by the detection portion.

In this communication processing device, a communication error status with the home electric device is detected, and the detected communication error status is stored, so that the transmission rate with the home electric device can be set on the basis of the stored last communication error status and the latest communication error status that is just detected. It is thus possible to set the transmission rate with the home electric device according to the history of the communication error status, which in turn makes it possible to set an optimal transmission rate in accordance with the communication environment with the home electric device.

Another aspect of the invention provides a communication processing device that links a home electric device to a network, including: a communication portion that sends/receives data to/from the home electric device; a save portion that saves plural transmission rates settable in the communication processing device; and a setting portion that sets a transmission rate on a basis of plural transmission rates settable in the home electric device and received at the communication portion and the plural transmission rates saved in the save portion.

In this communication processing device, during the negotiation when connected to the home electric device, the home electric device can specify plural settable transmission rates, while the communication processing device can select an appropriate transmission rate among the plural transmission rates thus specified. The transmission rate negotiation can be therefore completed in a short communication time with a single sending and receiving operation without having to wait for a time-out. It is thus possible to perform the communication procedure efficiently in a short time during the negotiation between multi-rate home electric device and communication processing device.

A further aspect of the invention provides a home electric device that is linked to a network via a communication processing device, including: a communication portion that sends/receives data to/from the communication processing device; a storage portion that stores a communication error status with the communication processing device; and a setting portion that sets a transmission rate with the communication processing device on a basis of communication error statuses in past times stored in the storage portion.

In this home electric device, the communication error statuses with the communication processing device are stored, so that the transmission rate with the communication processing device can be set on the basis of the stored communication error statuses in past times. It is thus possible to set an optimal transmission rate in accordance with the communication environment with the communication processing device.

Still another aspect of the invention provides a home electric device that is linked to a network via a communication processing device, including: a save portion that saves plural transmission rates settable in the home electric device; a generation portion that generates supported transmission rate specifying information to inform the plural transmission rates saved in the save portion; and a communication portion that sends the supported transmission rate specifying information to the communication processing device.

In this home electric device, during the negotiation when connected to the communication processing device, the home electric device can specify plural settable transmission rates, while the communication processing device can select an appropriate transmission rate among the plural transmission rates thus specified. The transmission rate negotiation can be therefore completed in a short communication time with a single sending and receiving operation without having to wait for a time-out. It is thus possible to perform the communication procedure efficiently in a short time during the negotiation between multi-rate home electric device and communication processing device.

### BRIEF DESCRIPTION OF THE DRAWINGS

FIG. 1 is a block diagram showing the configurations of a home electric device and a communication processing device according to a first embodiment of the invention;

FIG. 2 is a block diagram showing the configuration of a device interface inside the communication processing device shown in FIG. 1;

FIG. 3 is a block diagram showing the configuration of a home electric interface inside the home electric device shown in FIG. 1;

FIG. 4 is a view showing a connection sequence between the home electric device and the communication processing device shown in FIG. 1;

FIG. 5 is a flowchart detailing the processing procedure for the home electric device shown in FIG. 1 to send a line connection request;

FIGS. 6A and 6B are views showing one example of a typical frame structure of data and one example of a concrete frame structure transmitted between the home electric device and the communication processing device;

FIG. 7 is a view showing one example of a code configuration of supported transmission rate specifying information in the line connection request;

FIG. 8 is a flowchart detailing the processing procedure for the communication processing device shown in FIG. 1 to send a line connection reply;

FIG. 9 is a view showing one example of a code configuration of selected transmission rate information in the line connection reply;

FIG. 10 is a flowchart detailing the processing procedure for the home electric device shown in FIG. 1 to send a line connection finalization notice;

FIG. 11 is a flowchart detailing the procedure for the communication processing device shown in FIG. 1 to select the transmission rate;

FIG. 12 is a block diagram showing the configurations of a home electric device and a communication processing device according to a second embodiment of the invention;

FIG. 13 is a view showing one example of a normally OFF home electric device;

FIG. 14 is a view showing one example of an always ON home electric device;

FIG. 15 is a view showing one example of a stand-by home electric device;

FIG. 16 is a block diagram showing the configuration of a device interface shown in FIG. 12;

FIG. 17 is a view showing the sequence used to describe one example of transmission rate negotiation processing between the home electric device and the communication processing device in the initial state;

FIG. 18 is a view showing the sequence used to describe another example of the transmission rate negotiation processing between the home electric device and the communication processing device in the initial state;

FIG. 19 is a view showing the sequence to describe one example of the transmissions rate negotiation processing between the home electric device and the communication processing device when the last transmission rate and the failure/success of communications are stored in a transmission rate storage portion;

FIG. 20 is a flowchart detailing device interface information reply sending processing by the home electric device shown in FIG. 12;

FIG. 21 is a flowchart detailing device interface information finalization notice sending processing by the communication processing device shown in FIG. 12;

FIG. 22 is a flowchart detailing communication error detection processing by the communication processing device shown in FIG. 12;

FIG. 23 is a flowchart detailing communication error ratio reset processing by the communication processing device shown in FIG. 12;

FIG. 24 is a flowchart detailing transmission rate re-negotiation processing by the communication processing device shown in FIG. 12 for the normally OFF home electric device;

FIGS. 25A to 25D are views used to describe a method for determining the transmission rate on the basis of the last communication error ratio and the latest communication error ratio;

FIGS. 26A to 26C are views used to describe a manner in which the transmission rate is determined in response to a change of the transmission rate;

FIGS. 27A and 27B are views showing one example of a change of the communication error ratio and a change of the transmission rate;

FIG. 28 is a flowchart detailing transmission rate re-negotiation processing by the communication processing device shown in FIG. 12 for the always ON home electric device;

FIG. 29 is a flowchart detailing transmission rate re-negotiation processing by the communication processing device shown in FIG. 12 for the stand-by home electric device; and

FIG. 30 is a connection sequence in the related art when components are connected.

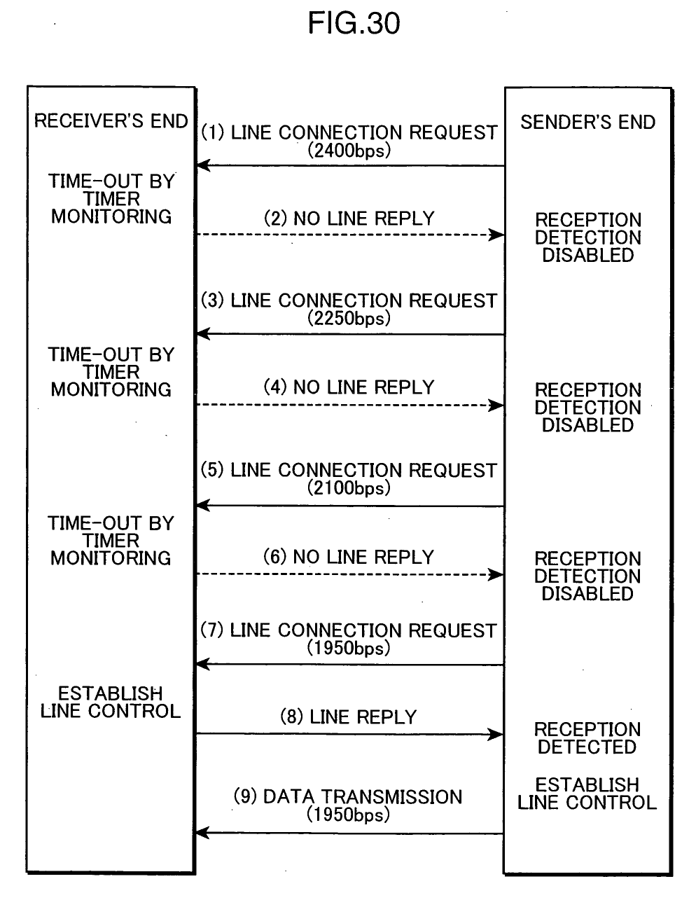

### BEST MODE FOR CARRYING OUT THE INVENTION

Hereinafter, respective embodiments of the invention will be described with reference to the drawings.

### First Embodiment

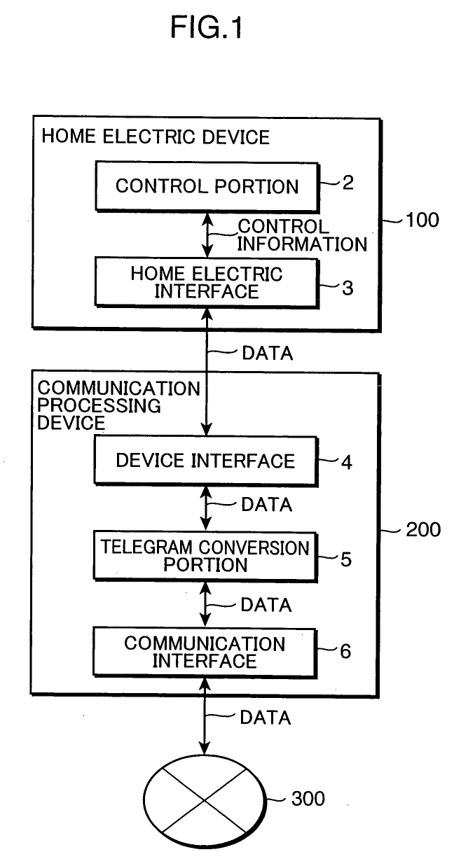

FIG. 1 is a block diagram showing the configurations of a home electric device and a communication processing device according to a first embodiment of the invention. As is shown in FIG. 1, a home electric device 100 in the user's home is linked to a network 300 via a communication processing device 200, and a home network system is constructed from the home electric device 100, the communication processing device 200, etc. The network 300 is a line that can be linked to a controller that controls the home electric device and to other home electric devices.

The home electric device 100 is one of the so-called white goods, such as an air conditioner and a refrigerator, or a sensor, such as a human detection sensor and an opening/closing sensor. The home electric device 100 and the communication processing device 200 make communications according to a specific protocol (for example, the ECHONET (Energy Conservation and Homecare Network) standard). A home electric interface 3 is provided inside the home electric device 100 as means for sending and receiving data. The home electric interface 3 comprises a microcomputer provided with an arithmetic processing unit, a memory, etc. A connection mode between the home electric device 100 and the communication processing device 200 is a serial interface (for example, 8 pins), and data transmission and supply of power are enabled. A control portion 2 sends/receives control information and the like to control the home electric device 100 to/from the home electric interface 3. The connection mode between the home electric device 100 and the communication processing device 200 is not limited to the example above, and another connection mode, such as a wireless communication method, can be used as well.

As internal components of the communication processing device 200, a device interface 4, a telegram conversion portion 5, and a communication interface 6 are provided. The device interface 4 comprises a microcomputer provided with an arithmetic processing unit, memory, etc., and serves as means for sending/receiving data to/from the home electric device 100. The communication interface 6 is means for sending/receiving data to/from the network 300. As a connection mode to transmit data between the network 300 and the communication processing device 200, various communication methods, such as the power line communication method, the specific low power radio method, and the Bluetooth™ method, are available.

Because the device interface 4 and the communication interface 6 use different protocols, data is transmitted between these two interfaces via the telegram conversion portion 5. More specifically, the telegram conversion portion 5 converts data sent from the device interface 4 to data that the communication interface 6 can process, and delivers the converted data to the communication interface 6. Meanwhile, the telegram conversion portion 5 converts data sent from the communication interface 6 to data that the device interface 4 can process, and delivers the converted data to the device interface 4.

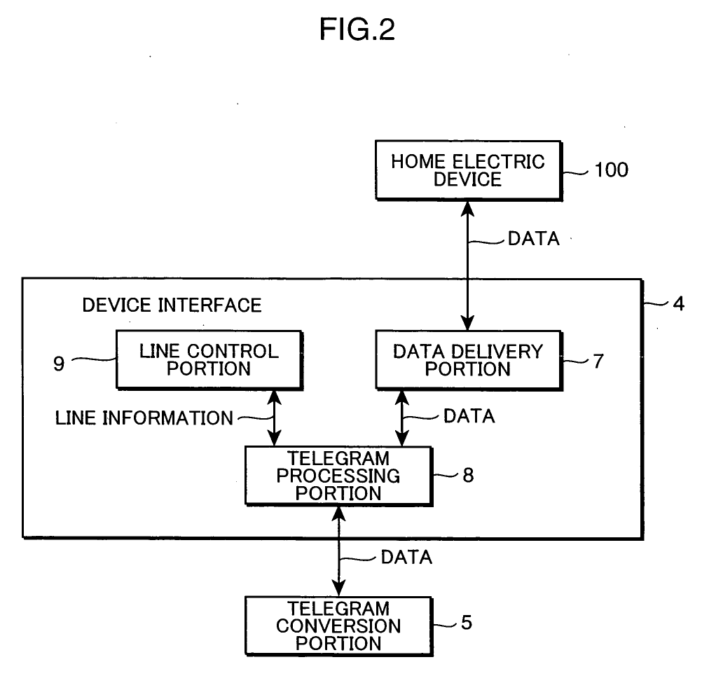

FIG. 2 is a block diagram showing the configuration of the device interface 4 inside the communication processing device 200 of FIG. 1. As is shown in FIG. 2, the device interface 4 is provided with a data delivery portion 7, a telegram processing portion 8, and a line control portion 9.

The data delivery portion 7 is means for sending/receiving data to/from the home electric device 100, and the telegram processing portion 8 is means for performing specific protocol processing on the data. The telegram processing portion 8 also delivers data to be sent to the network 300 to the telegram conversion portion 5. The line control portion 9 controls the transmission method and the transmission rate of the line. The line control portion 9 is furnished with a function of monitoring a line condition, and therefore also delivers line information about the line condition, the transmission method, and the transmission rate to the telegram processing portion 8. Further, when the home electric device 100 and the communication processing device 200 are connected to each other, the line control portion 9 notifies the telegram processing portion 8 of the connection to the home electric device 100. In this instance, the telegram processing portion 8 notifies the data delivery portion 7 that sending of data is enabled in the form of the line information. Supply of power is known as an example when the line control portion 9 detects the connection to the home electric device 100.

When the connection is confirmed, the negotiation to determine the transmission rate and the transmission method is started between the home electric device 100 and the communication processing device 200. When the negotiation is completed, communications between the communication interface 6 and the network 300 are started, and the home electric device 100 is therefore allowed to access the network 300. For the negotiation taking place herein, a plug-in by which the user does not make any setting and all the settings are made automatically is preferable.

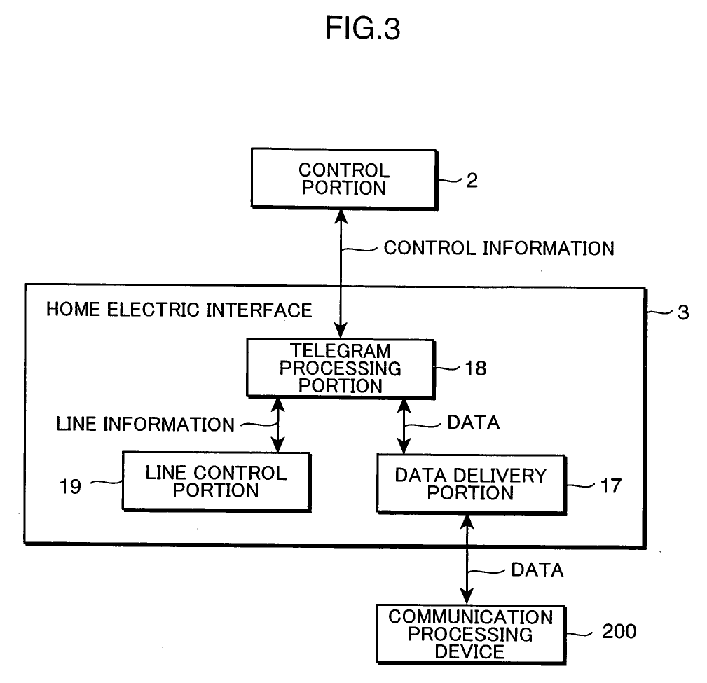

FIG. 3 is a block diagram showing the configuration of the home electric interface 3 inside the home electric device 100 of FIG. 1. As with the device interface 4, the home electric interface 3 comprises a data delivery portion 17 serving as means for sending and receiving data, a telegram processing portion 18 serving as means for performing specific protocol processing on data, and a line control portion 19 serving as means for monitoring the line condition by controlling the transmission method and the transmission rate of the line. The telegram processing portion 18 is furnished with a function of delivering the control information among the input data to the control portion 2 and subjecting the control information from the control portion 2 to protocol processing. Because communications among the telegram conversion portion 5, the communication interface 6, and the network 300 after the completion of the negotiation in FIG. 1 are not directly related to the invention, the detailed configuration is omitted herein.

In this embodiment, the communication processing device 200 corresponds to one example of a communication processing device, the data delivery portion 7 corresponds to one example of a communication portion, the line control portion 9 corresponds to one example of a save portion, and the telegram processing portion 8 corresponds to one example of a setting portion. Also, the home electric device 100 corresponds to one example of a home electric device, the line control portion 19 corresponds to one example of a save portion, the telegram processing portion 18 corresponds to one example of a generation portion and a setting portion, and the data delivery portion 17 corresponds to one example of a communication portion.

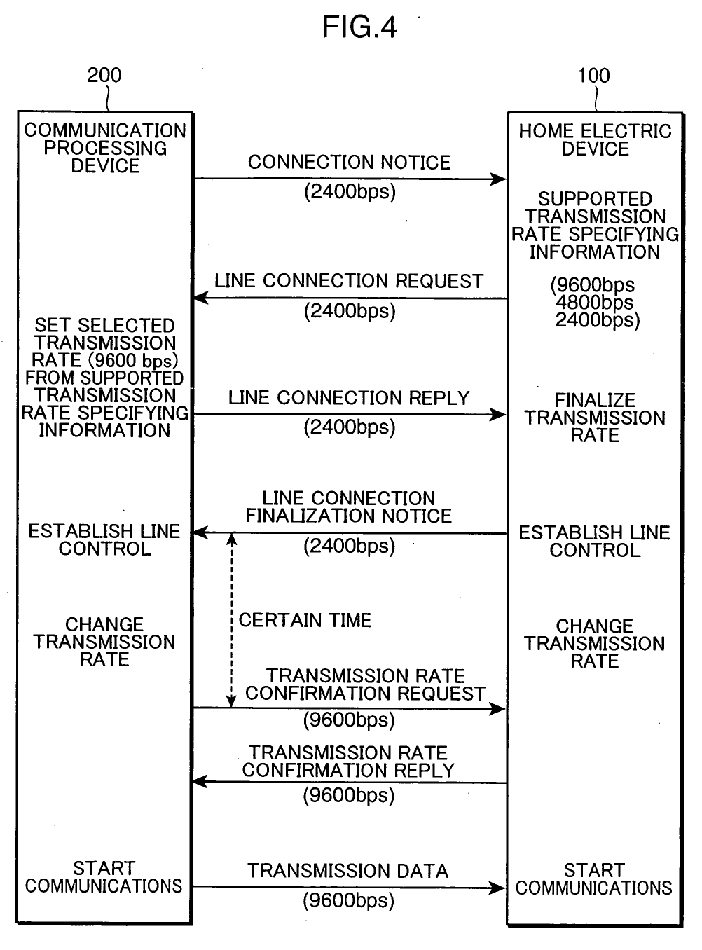

Operations of the first embodiment of the invention will now be described with reference to FIG. 4. FIG. 4 is a view showing the connection sequence between the home electric device 100 and the communication processing device 200 shown in FIG. 1. Assume that the communication processing device 200 is connected to the home electric device 100 for the first time. This is the negotiation between the home electric device 100 and the communication processing device 200, and no communications are made between the network 300 and the communication processing device 200.

The user either inserts a serial cable connected to the communication processing device 200 into a connector portion of the home electric device 100, or inserts a serial cable connected to the home electric device 100 into a connector portion of the communication processing device 200. In this instance, it is preferable that the power supply of the home electric device 100 is switched OFF for safety reasons.

After the home electric device 100 and the communication processing device 200 are connected to each other, the line control portion 9 in the communication processing device 200 detects that the connection is started as the power supply of the home electric device 100 is switched ON, and notifies the telegram processing portion 8 of the connection to the home electric device 100. The telegram processing portion 8 is triggered by this notice, and delivers a connection notice to the data delivery portion 7. The data delivery portion 7 then sends a connection notice to the home electric device 100.

A pre-set transmission rate is used as the transmission rate in this instance. This is because the home electric device 100 and the communication processing device 200, which are connected to each other via a serial cable, have a little data loss; moreover, reply data can be received in a reliable manner, and efficiency is higher than waiting for a time-out. In this embodiment, 2400 bps is used as one example of the pre-set transmission rate.

The home electric device 100 sets supported transmission rate specifying information that specifies plural settable transmission rates in the reply data to the connection notice, and sends a line connection request to the communication processing device 200. Settable transmission rates referred to herein mean transmission rates at which communications with the data delivery portion 17 in the home electric interface 3 are enabled, and they are pre-stored in the line control portion 19. For example, transmission rates, 2400 bps, 4800 bps, and 9600 bps, are saved as the supported transmission rate information.

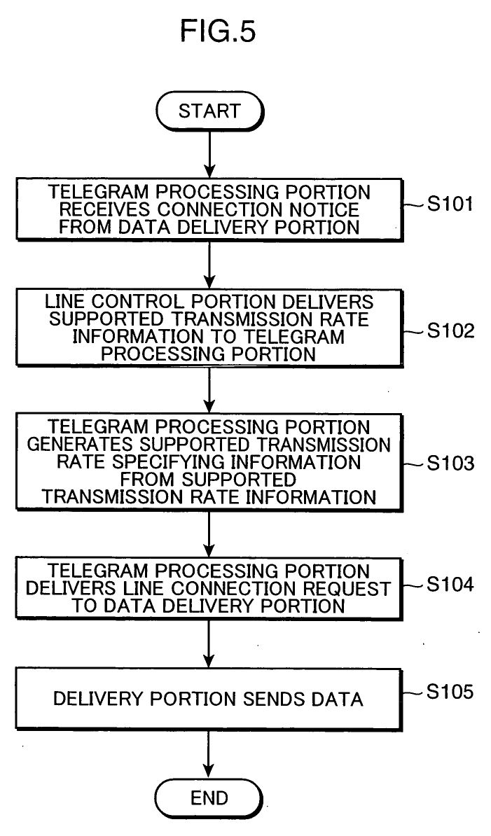

FIG. 5 is a flowchart detailing a processing procedure for the home electric device 100 shown in FIG. 1 to send the line connection request, which will be described in the following. Firstly, the telegram processing portion 18 receives the connection notice informing the connection of the home electric device 100 and the communication processing device 200 from the data delivery portion 17 (S101). Subsequently, the line control portion 19 delivers the supported transmission rate information specifying transmission rates that the home electric device 100 can support to the telegram processing portion 18 (S102). Subsequently, the telegram processing portion 18 generates the supported transmission rate specifying information from the supported transmission rate information, and then generates data of the line connection request in which the supported transmission rate specifying information is set (S103). Subsequently, the telegram processing portion 18 delivers the line connection request to the data delivery portion 17 (S104). Finally, the data delivery portion 17 sends the line connection request, which is the data containing the supported transmission rate specifying information (S105). An example of the frame configuration of the supported transmission rate specifying information will be described below.

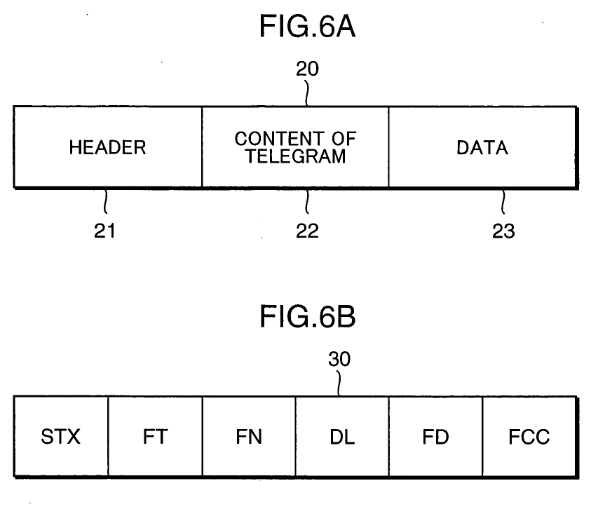

FIGS. 6A and 6B show one example of the frame configuration of the data. As is shown in FIG. 6A, the frame configuration 20 of typical data comprises a header 21, a telegram content 22, and data 23. Also, as is shown in FIG. 6B, a concrete frame configuration 30 of data transmitted between the home electric device 100 and the communication processing device 200 comprises an STX indicating a control code, an FT indicating a frame type, an FN indicating a frame nature, a DL indicating a data length code, an FD indicating data, and an FCC (Frame Check Code) indicating a check code. For example, for the frame of the line connection request, a value indicating a line connection is set in the FT, a value indicating a request in FN, and supported transmission rate specifying information, which is a code specifying transmission rates that the home electric device 100 can set therein, in the FD.

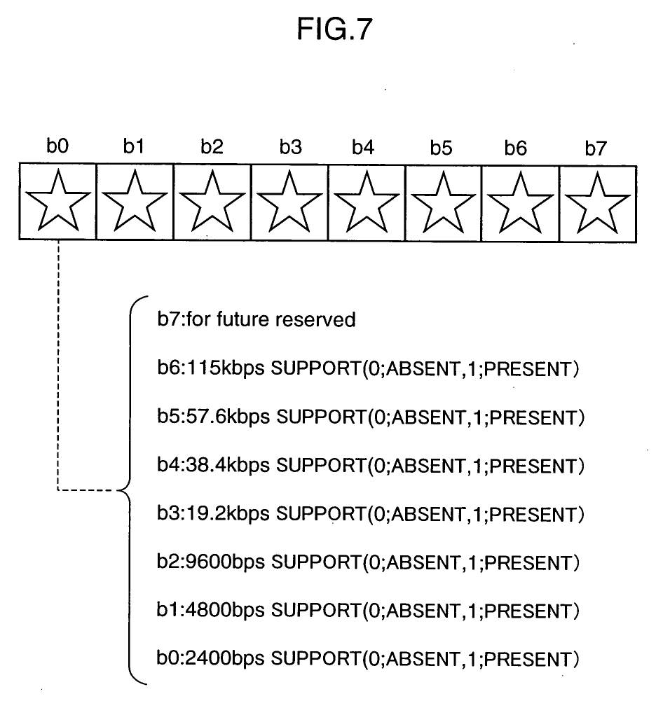

FIG. 7 shows one example of the code configuration of the supported transmission rate specifying information in the line connection request. In the first embodiment, the hexadecimal is used for the frame configuration, and binaries specifying respective transmission rates are set in respective bits in the supported transmission rate specifying information. For example, in a case where 9600 bps, 4800 bps, and 2400 bps are settable, because the supported transmission rate specifying information is represented by 11100000, E0 is set. In this manner, the home electric device 100 sets settable transmission rates in the supported transmission rate specifying information, and sends the line connection request to the communication processing device 200 as reply data. When the transmission rate is increased further to the extent that it can no longer be represented by 1-byte supported transmission rate specifying information, the supported transmission rate specifying information is increased to two bytes so that the supported transmission rates can be increased. It is thus possible to set plural settable transmission rates in a single frame in the line connection request.

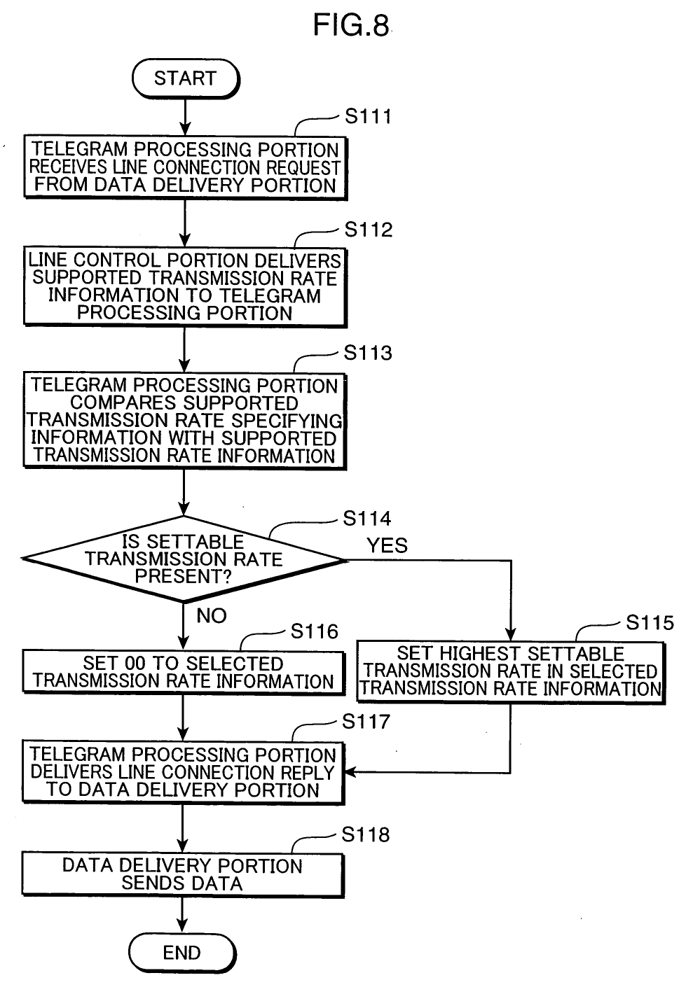

Subsequently, upon receipt of the line connection request, the communication processing device 200 sends a line connection reply to the home electric device 100 in the manner as follows. FIG. 8 is a flowchart detailing a processing procedure for the communication processing device 200 shown in FIG. 1 to send the line connection reply.

As is shown in FIG. 8, the telegram processing portion 8 first receives the line connection request from the data delivery portion 7 (S111). Subsequently, the line control portion 9 delivers the supported transmission rate information indicating transmission rates settable in the communication processing device 200 to the telegram processing portion 8 (S112). As with the home electric interface 3, the supported transmission rate information has been previously saved in the line control portion 9 in the device interface 4. Subsequently, the telegram processing portion 8 compares the supported transmission rate specifying information received from the home electric device 100 with the supported transmission rate information of the communication processing device 200 (S113), and judges the presence of settable transmission rates (S114). Upon judging the presence, the telegram processing portion 8 sets a highest settable transmission rate in selected transmission rate information (S115).

On the other hand, when the communication processing device 200 does not support any one of the transmission rates specified by the supported transmission rate specifying information, the selected transmission rate information is set to 00 (S116). After the selected transmission rate information is set, the telegram processing portion 8 delivers the line connection reply containing the selected transmission rate information to the data delivery portion 7 (S117). The data delivery portion 7 then sends the line connection reply containing the selected transmission rate information to the home electric device 100 in the form of data (S118).

The frame configuration of the line connection reply and the selected transmission rate information contained in the line connection reply will now be described. In the frame of the line connection reply, a value indicating a line connection is set in the FT, a value indicating a reply in the FN, and the selected transmission rate information in the FD (FIG. 6B). The selected transmission rate information is information indicating the result when an optimal transmission rate is selected in the communication processing device 200 among transmission rates specified by the supported transmission rate specifying information contained in the line connection request. Normally, the highest settable rate is set in the selected transmission rate information as the optimal transmission rate.

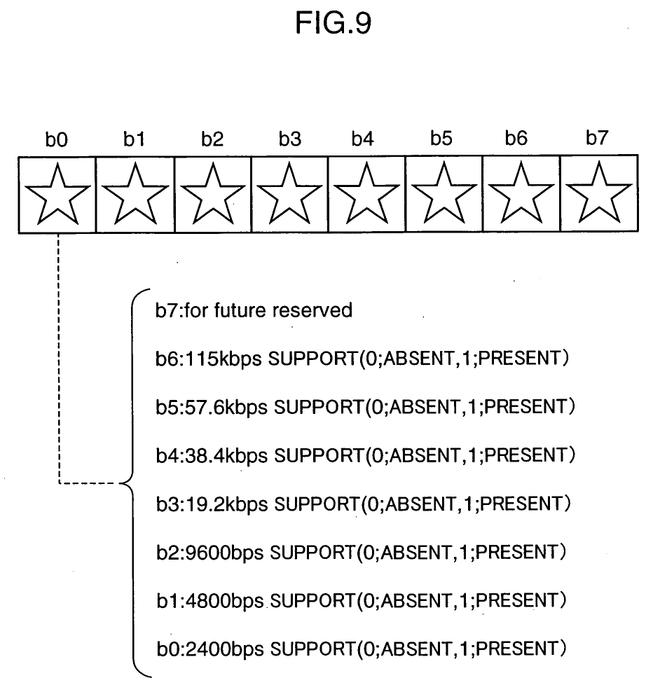

FIG. 9 shows one example of the code configuration of the selected transmission rate information in the line connection reply. As with the supported transmission rate specifying information shown in FIG. 7, transmission rates can be assigned to respective bits in the selected transmission rate information. As the setting method, a single bit indicating the highest transmission rate among coinciding transmission rates in the supported transmission rate specifying information and the supported transmission rate information from the line control portion 9 is specified. For example, when the supported transmission rate specifying information is set to E0, that is, it specifies 9600 bps, 4800 bps, and 2400 bps, and 9600 bps, 4800 bps, and 2400 bps are also settable in the communication processing device 200, the selected transmission rate is the highest transmission rate, 9600 bps, and the selected transmission rate information is represented by 00100000, that is, 20. The multi-rate home electric device 100 and communication processing device 200 are thus able to determine a transmission rate by a single sending and receiving operation.

Upon receipt of the line connection reply, the home electric device 100 sends a line connection finalization notice to the communication processing device 200. In the line connection finalization notice, a notice is set in the FN, and the set transmission rate information specifying the set transmission rate is set in the FD. The frame configuration of the set transmission rate information is identical with that of the selected transmission rate information of FIG. 9, and the description is omitted herein.

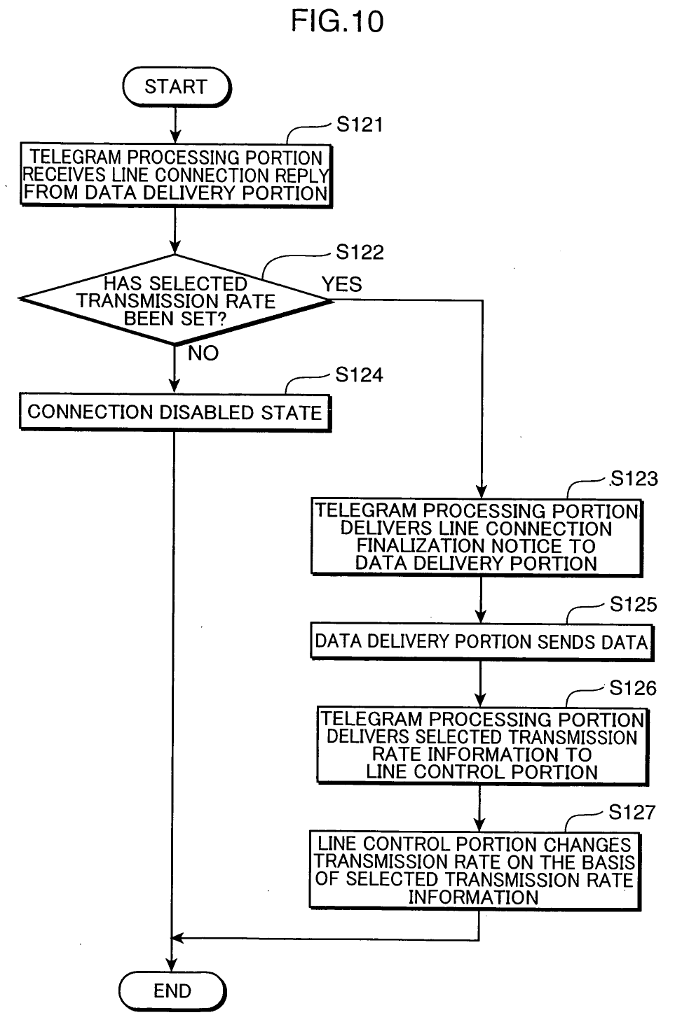

FIG. 10 is a flowchart detailing a processing procedure for the home electric device 100 shown in FIG. 1 to send the line connection finalization notice. As is shown in FIG. 10, in the home electric device 100, the telegram processing portion 18 receives the line connection reply from the data delivery portion 17 (S121), and judges whether the selected transmission rate has been set (S122). When the selected transmission rate has been set, the telegram processing portion 18 delivers the line connection finalization notice indicating the establishment of the line control to the data delivery portion 17 (S123). The data delivery portion 17 then sends the line connection finalization notice to the communication processing device 200 (S125). Subsequently, the telegram processing portion 18 delivers the selected transmission rate information to the line control portion 19 (S126). The line control portion 19 then changes the transmission rate on the basis of the selected transmission rate information (S127). For example, the transmission rate is set to 9600 bps.

When the selected transmission rate information is 00, that is, it is judged that the selected transmission rate has not been set, (NO in S122), the state transits to a connection disabled state (S124). The negotiation at the time of connection is thus suspended, and a red LED is lit on to notify the user of the disabled connection. The current transmission rate may be set to a transmission rate in the supported transmission rate specifying information, so that the line connection request can be sent again for the transmission rate negotiation to be resumed.

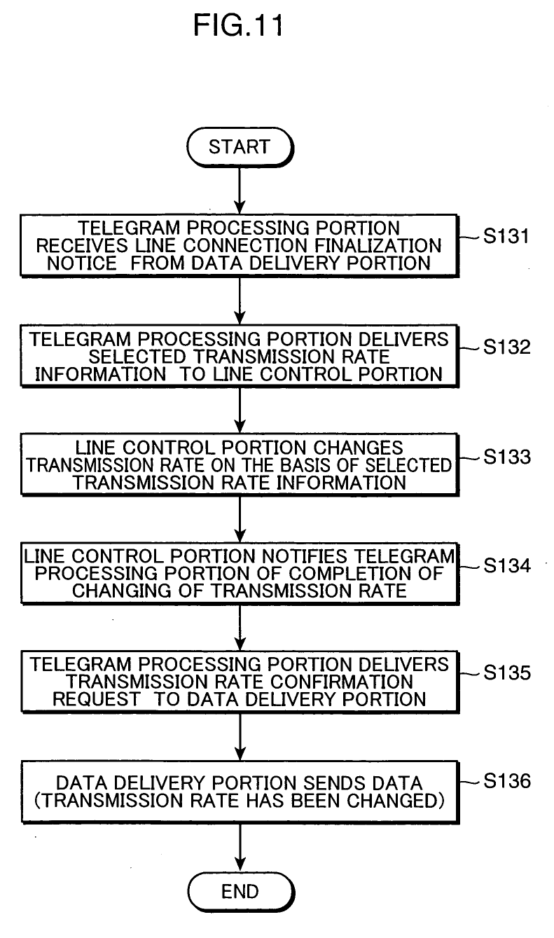

A processing procedure of the communication processing device 200 after the reception of the line connection finalization notice will now be described. FIG. 11 is a flowchart detailing a procedure for the communication processing device 200 shown in FIG. 1 to select the transmission rate.

As is shown in FIG. 11, in the communication processing device 200, the telegram processing portion 8 receives the line connection establishment notice from the data delivery portion 7 (S131), and delivers the selected transmission rate information to the line control portion 9 (S132). Subsequently, the line control portion 9 changes the transmission rate on the basis of the selected transmission rate information (S133), and notifies the telegram processing portion 8 of the completion of the changing of the transmission rate (S134). Upon receipt of the completion of the changing of the transmission rate, the telegram processing portion 18 delivers a transmission rate confirmation request to the data delivery portion 17 (S135). The data delivery portion 17 then sends a transmission rate confirmation request in the form of data at the changed transmission rate (in this embodiment, 9600 bps) (S136).

Herein, the transmission rate confirmation request is a sequence to confirm whether the transmission rate has been changed to the selected transmission rate. In the frame configuration of the transmission rate confirmation request, a value indicating a transmission rate confirmation is set in the FT, a value indicating a request in FN, and the selected transmission rate in the FD (FIG. 6B). In order to switch the transmission rates in a reliable manner, it is preferable that the data delivery portion 7 secures an interval of a certain time since the reception of the line connection confirmation notice until it sends the transmission rate confirmation request.

Upon receipt of the transmission rate confirmation request from the data delivery portion 17 in the home electric device 100, the telegram processing portion 18 delivers a transmission rate confirmation reply indicating a reply to the transmission rate confirmation request to the data delivery portion 17. In the frame configuration of the transmission rate confirmation reply, a value indicating a transmission rate confirmation is set in the FT, and a value indicating a reply in the FN, and a value indicating TRUE in FD (FIG. 6B). The transmission rate negotiation between the home electric device 100 and the communication processing device 200 at the time of connection is completed when the telegram processing portion 8 in the communication processing device 200 receives the transmission rate confirmation reply. In a case where the FD in the transmission rate confirmation reply is a value indicating FALSE or no transmission is received, it is preferable that the communication processing device 200 sends the transmission rate confirmation request again.

When configured in this manner, the negotiation between the multi-rate home electric device 100 and communication processing device 200 can be completed by: sending the line connection request containing the supported transmission rate specifying information that can specify plural transmission rates settable in the home electric device 100; comparing the supported transmission rate specifying information with the supported transmission rate information indicating transmission rates settable in the communication processing device 200 to select a selected transmission rate; receiving the line connection reply containing the selected transmission rate information specifying the selected transmission rate; sending the line connection finalization notice informing the establishment of the line control; and sending and receiving the transmission rate confirmation request and the transmission rate confirmation reply as a confirmation after the transmission rate is changed. It is thus possible to complete the negotiation at the time of connection in a time far shorter than by the fallback procedure using a time-out.

In this embodiment, the supported transmission rate specifying information is sent from the home electric device 100 and the selected transmission rate information is sent from the communication processing device 200. However, it may be configured in such a manner that the supported transmission rate specifying information is sent from the communication processing device 200, and the selected transmission rate information is sent from the home electric device 100.

In addition, the negotiation of the invention effectively functions not only at time of connection, but also at the re-start-up when the home electric device 100 and the communication processing device 200 have a communication failure.

### Second Embodiment

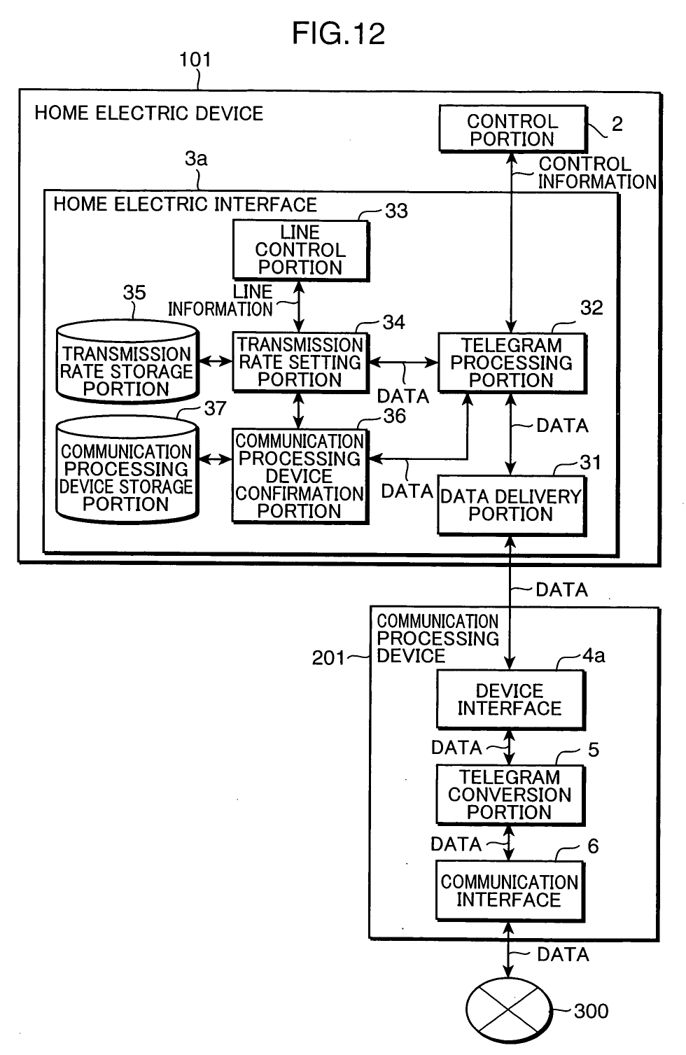

FIG. 12 is a block diagram showing the configurations of a home electric device and a communication processing device according to a second embodiment of the invention. As is shown in FIG. 12, a home electric device 101 in the user's home is linked to a network 300 via a communication processing device 201, and a home network system is constructed from the home electric device 101, the communication processing device 201, etc. A connection mode between the home electric device 101 and the communication processing device 201 is a serial interface (for example, 8 pins), and data transmission and supply of power are enabled. The network 300 is of the same configuration as the counterpart in the first embodiment, and communications between the communication processing device 201 and the network 300 are made in the same manner as in the first embodiment.

The home electric device 101 is one of the so-called white goods, such as an air conditioner and a refrigerator, or a sensor, such as a human detection sensor and an opening/switching sensor. In this embodiment, the home electric device is classified into three types: a normally OFF home electric device, an always ON home electric device, and a stand-by home electric device. The home electric device 101 corresponds to any one of the normally OFF home electric device, the always ON home electric device, and the stand-by home electric device.

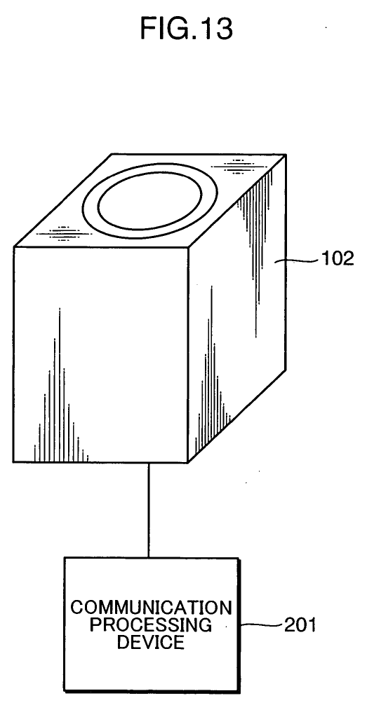

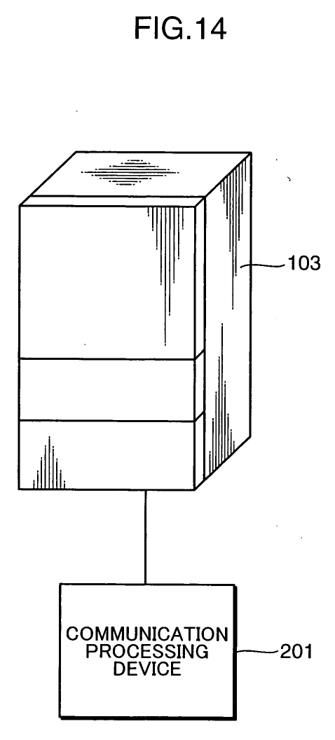

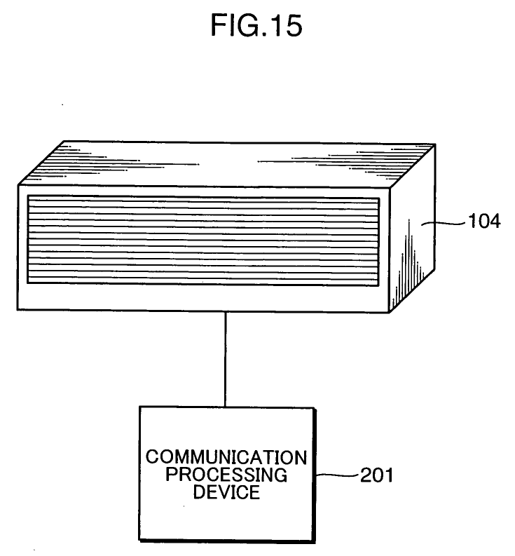

FIG. 13 is a view showing one example of the normally OFF home electric device. FIG. 14 is a view showing one example of the always ON home electric device. FIG. 15 is a view showing one example of the stand-by home electric device. The normally OFF home electric device is a home electric device for which the power supply is switched OFF when not in use and the power supply is switched ON when used, and the power supply is normally in the OFF state. For example, a washing machine 102 shown in FIG. 13 corresponds to the normally OFF home electric device. The always ON home electric device is a home electric device that is kept run with the power supply being kept switched ON, and the power supply is normally in the ON state. For example, a refrigerator 103 shown in FIG. 14 corresponds to the always ON home electric device. The stand-by home electric device is a home electric device for which the power supply is in the stand-by state when not in use and the power supply is switched ON when used, and the power supply is normally in the stand-by state. For example, an air conditioner 104 shown in FIG. 15 corresponds to the stand-by home electric device.

When the washing machine 102, the refrigerator 103, and the air conditioner 104 are home electric devices in compliance with the ECHONET standard, the washing machine 102, the refrigerator 103, and the air conditioner 104 are ECHONET-ready devices, and the communication processing device 201 is an ECHONET middleware adapter. Data communications are made between the two components according to the ECHONET standard.

Referring to FIG. 12 again, the home electric device 101 is provided with a control portion 2, and a home electric interface 3a, while the communication processing device 201 is provided with a device interface 4a, a telegram conversion portion 5, and a communication interface 6.

The control portion 2 sends/receives control information and the like to control the home electric device 101 to/from the home electric interface 3a. The home electric interface 3a comprises a microcomputer provided with an arithmetic processing unit, memory, etc., and sends/receives data to/from the communication processing device 201. The device interface 4a comprises a microcomputer provided with an arithmetic processing device, a memory, etc., and sends/receives data to/from the home electric device 101. The communication interface 6 sends/receives data to/from the network 300. Because the device interface 4a and the communication interface 6 use different communication protocols, the telegram conversion portion 5 converts data sent from the device interface 4a to data that the communication interface 6 can process, and outputs the converted data to the communication interface 6. The telegram conversion portion 5 also converts data sent from the communication interface 6 to data that the device interface 4a can process, and outputs the converted data to the device interface 4a.

The home electric interface 3a includes a data delivery portion 31, a telegram processing portion 32, a line control portion 33, a transmission rate setting portion 34, a transmission rate storage portion 35, a communication processing device confirmation portion 36, and a communication processing device storage portion 37.

The data delivery portion 31 sends/receives data to/from the communication processing device 201. The telegram processing portion 32 extracts control information from the data outputted from the data delivery portion 31, and outputs the extracted control information to the control portion 2. The telegram processing portion 32 performs specific protocol processing on the control information or the like outputted from the control portion 2 and outputs the resulting information to the data delivery portion 31.

The line control portion 33 receives data about the line from the telegram processing portion 32 via the transmission rate setting portion 34, and monitors the line condition by controlling the transmission method and the transmission rate of the line. Also, the line control portion 33 has previously stored plural transmission rates that the home electric device 101 supports.

The transmission rate setting portion 34 receives the line information about the line condition, the transmission method, the transmission rate, etc. from the line control portion 33, and stores a transmission rate at which communications failed and a transmission rate at which communications succeeded in the transmission rate storage portion 35, and sets a current transmission rate on the basis of the last transmission rate and the failure/success of communications stored in the transmission rate storage portion 35. The transmission rate storage portion 35 comprises a non-volatile memory, such as a flash memory, and the last transmission rate and the failure/success of communications are kept saved even when the power supply is switched OFF.

The communication processing device confirmation portion 36 receives identification information of the communication processing device 201 via the data delivery portion 31 and the telegram processing portion 32, and stores the identification information of the communication processing device 201 in the communication processing device storage portion 37. The communication processing device storage portion 37 comprises a non-volatile memory, such as a flash memory, and the identification information of the communication processing device 201 or the like is kept saved even when the power supply is switched OFF.

When a communication processing device is newly connected, the communication processing device confirmation portion 36 compares the identification information of the newly connected communication processing device with the identification information stored in the communication processing device storage portion 37, and confirms whether the newly connected communication processing device is the communication processing device at the transmission rate stored in the transmission rate storage portion 35, after which it notifies the transmission rate setting portion 34 of the confirmation result. When the connected-communication processing device is the communication processing device at the transmission rate stored in the transmission rate storage portion 35, the transmission rate setting portion 34 sets a current transmission rate on the basis of the last transmission rate and the failure/success of last communication stored in the transmission rate storage portion 35. On the other hand, when the connected-communication processing device is not the communication processing device at the transmission rate stored in the transmission rate storage portion 35, the transmission rate setting portion 34 sets a current transmission rate on the basis of the transmission rate saved in the line control portion 33.

The transmission rate setting portion 34 notifies the telegram processing portion 32 of the transmission rate set as described above, and the data delivery portion 31 sends/receives data using the transmission rate set by the transmission rate setting portion 34.

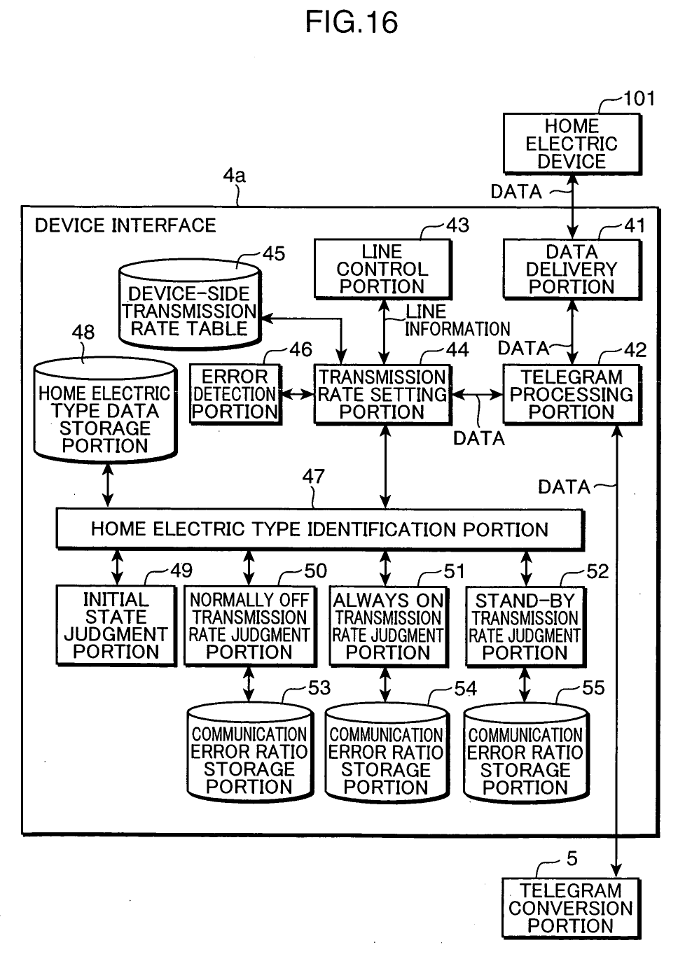

FIG. 16 is a block diagram showing the configuration of the device interface 4a shown in FIG. 12. As is shown in FIG. 16, the device interface 4a includes a data delivery portion 41, a telegram processing portion 42, a line control portion 43, a transmission rate setting portion 44, a device-side transmission rate table 45, an error detection portion 46, a home electric type identification portion 47, a home electric type data storage portion 48, an initial state judgment portion 49, a normally OFF transmission rate judgment portion 50, an always ON transmission rate judgment portion 51, a stand-by transmission rate judgment portion 52, and communication error ratio storage portions 53 through 55.

The data delivery portion 41 sends/receives data to/from the home electric device 101. The telegram processing portion 42 performs specific protocol processing on the input/output data, and outputs data to be sent to the network 300 to the telegram conversion portion 5. The line control portion 43 receives data about the line from the telegram processing portion 42 via the transmission rate setting portion 44, and monitors the line condition by controlling the transmission method and the transmission rate of the line. Also, the line control portion 43 has previously stored plural transmission rates that the communication processing device 201 supports.

Further, when the home electric device 101 and the communication processing lines 201 are connected to each other, the line control portion 43 notifies the transmission rate setting portion 44 of the connection to the home electric device 101. The transmission rate setting portion 44 then notifies the telegram processing portion 42 of the connection to the home electric device 101. In this instance, the telegram processing portion 42 notifies the data delivery portion 41 that sending of data is enabled in the form of line information. An example when the line control portion 43 detects the connection is the supply of power. Also, the line control portion 43 detects that the power supply of the home electric device 101 is switched to the stand-by state from the ON state, and notifies the transmission rate setting portion 44 of the switching.

The transmission rate setting portion 44 receives the line information about the line condition, the transmission method, the transmission rate, etc. from the line control portion 43, and sets a transmission rate at which communications are enabled by comparing plural transmission rates that the communication processing device 201 supports with the transmission rate informed from the home electric device 101. The transmission rate setting portion 44 then stores the transmission rate thus set in the device-side transmission rate table 45.

The device-side transmission rate table 45 comprises a non-volatile memory, such as a flash memory, and even when the power supply is switched OFF, one or more than one transmission rate set before (a transmission rate at which the communication negotiation was established between the home electric device 101 and the communication processing device 201) is saved cumulatively, and saves the transmission rate that the transmission rate setting portion 44 has newly set to be distinguishable from other transmission rates set before as the last transmission rate. Also, when the home electric device 100 shown in FIG. 1 and the communication processing device 201 shown in FIG. 12 are connected to each other, the supported transmission rate specifying information may be received from the home electric device 100, so that, of plural supported transmission rates of the home electric device 100, one or more than one transmission rate (a transmission rate at which communications are enabled between the home electric device 100 and the communication processing device 201) that the communication processing device 201 supports is stored in the device-side transmission rate table 45.

The error detection portion 46 receives data outputted from the telegram processing portion 42 via the transmission rate setting portion 44, and detects a communication error with the home electric device 101 on the basis of an FCC error or a parity error contained in the inquiry request and the processing result.

The home electric type data storage portion 48 stores device object information to identify each home electric device and home electric type information to identify a type of the home electric device which are correlated with each other for each home electric device. For example, in the tabular form, the device object information indicating a washing machine is stored in correlation with the home electric type information indicating the normally OFF home electric device, the device object information indicating a refrigerator is stored in correlation with the home electric type information indicating the always ON home electric device, and the device object information indicating an air conditioner is stored in correlation with the home electric type information indicating the always ON home electric device.

The home electric type identification portion 47 receives the device object information from the home electric device 101 via the data delivery portion 41, the telegram processing portion 42, and the transmission rate setting portion 44, and reads out the home electric type information correlated with the device object information of the home electric device 101 by referring to the home electric type data storage portion 48 to identify the home electric device 101 as any one of the normally OFF home electric device, the always ON home electric device, and the stand-by home electric device, after which it stores the identification result. Also, the home electric type identification portion 47 receives the error detection result from the error detection portion 46 via the transmission rate setting portion 44, and outputs the error detection result to any one of the normally OFF transmission rate judgment portion 50, the always ON transmission rate judgment portion 51, and the stand-by transmission rate judgment portion 52 depending on the identified home electric type.

The initial state judgment portion 49 makes an inquiry to the home electric type identification portion 47 about the availability of the error detection result. When the error detection result is not available, it directs the transmission rate setting portion 44 to determine the transmission rate in the initial state via the home electric type identification portion 47.

When the home electric device 101 is the normally OFF home electric device, upon receipt of the error detection result from the home electric type identification portion 47, the normally OFF transmission rate judgment portion 50 calculates a latest communication error ratio. The normally OFF transmission rate judgment portion 50 then stores the communication error ratio that has been stored in the communication error ratio portion 53 as the last error ratio in the communication error ratio storage portion 53, and also stores the latest communication error ratio in the communication error ratio storage portion 53. Also, when the home electric device 101 is the normally OFF home electric device, the normally OFF transmission rate judgment portion 50 judges whether the transmission rate should be increased or decreased on the basis of the last error communication error ratio and the latest communication error ratio stored in the communication error ratio storage portion 53, and outputs the judgment result to the transmission rate setting portion 44 via the home electric type identification portion 47.

When the home electric device 101 is the always ON home electric device, upon receipt of the error detection result from the home electric type identification portion 47, the always ON transmission rate judgment portion 51 calculates the latest communication error ratio. The always ON transmission rate judgment portion 51 then stores the communication error ratio that has been stored in the communication error ratio storage portion 54 as the last error ratio in the communication error ratio storage portion 54, and also stores the latest communication error ratio in the communication error ratio storage portion 54. When the home electric device 101 is the always ON home electric device, the always ON transmission rate judgment portion 51 judges whether the transmission rate should be increased or decreased on the basis of the last communication error ratio and the latest communication error ratio stored in the communication error ratio storage portion 54, and outputs the judgment result to the transmission rate setting portion 44 via the home electric type identification portion 47.

When the home electric device 101 is the stand-by home electric device, upon receipt of the error detection result from the home electric type identification portion 47, the stand-by transmission rate judgment portion 52 calculates the latest communication error ratio. The stand-by transmission rate judgment portion 52 then stores the communication error ratio that has been stored in the communication error ratio storage portion 55 as the last error ratio in the communication error ratio storage portion 54, and also stores the latest communication error ratio in the communication error ratio storage portion 55. Also, when the home electric device 101 is the stand-by home electric device, the stand-by transmission rate judgment portion 52 judges whether the transmission rate should be increased or decreased on the basis of the last communication error ratio and the latest communication error ratio stored in the communication error ratio storage portion 55, and outputs the judgment result to the transmission rate setting portion 44 via the home electric type identification portion 47.

Each of the communication error storage portions 53 through 55 comprises a non-volatile memory, such as a flash memory or the like, and even when the power supply is switched OFF, the last communication error ratio and the latest communication error ratio are kept saved. The communication error statuses stored in the communication error ratio storage portions 53 through 55 are not limited to the communication error ratio, and various other indices indicating a communication error can be used as well.

The transmission rate setting portion 44 receives the judgment results made by the initial state judgment portion 49, the normally OFF transmission rate judgment portion 50, the always ON transmission rate judgment portion 51, and the stand-by transmission rate judgment portion 52 via the home electric type identification portion 47 as has been described, and sets the transmission rate on the basis of the judgment result. The transmission rate setting portion 44 then notifies the telegram processing portion 42 of the transmission rate thus set. The data delivery portion 41 thus sends and receives data at the transmission rate set by the transmission rate setting portion 44.

When the home electric device 101 and the communication processing device 201 configured as described above are connected to each other and power is supplied from the home electric device 101 to the communication processing device 201, the line control portion 43 detects the connection to the home electric device 101, and the negotiation to determine the transmission rate and the transmission method is started between the home electric device 101 and the communication processing device 201. When the negotiation is completed, communications between the communication interface 6 and the network 300 are started, and the home electric device 101 is therefore allowed to access the network 300.

In this embodiment, the communication processing device 201 corresponds to one example of a communication processing device, the data delivery portion 41 corresponds to one example of a communication portion, the error detection portion 46, the normally OFF transmission rate judgment portion 50, the always ON transmission rate judgment portion 51, and the stand-by transmission rate judgment portion 52 correspond to one example of a detection portion, the communication error ratio storage portions 53 through 55 correspond to one example of a storage portion, the transmission rate setting portion 44 corresponds to one example of a setting portion, the home electric type identification portion 47 corresponds to one example of an identification portion, the communication error ratio storage portion 53 corresponds to one example of a normally OFF storage portion, the communication error ratio storage portion 54 corresponds to one example of an always ON storage portion, and the communication error ratio storage portion 55 corresponds to one example of a stand-by storage portion. Also, the home electric device 101 corresponds to one example of a home electric device, the data delivery portion 31 corresponds to one example of a communication portion, the transmission rate storage portion 35 corresponds to one example of a storage portion, and the transmission rate setting portion 34 corresponds to one example of a setting portion.

Operations of the home electric device 101 and the communication processing device 201 configured as described above will now be described. Assume that the home electric device 101 and the communication processing device 201 make communications according to the communication standard, in which, for example, 2400 bps, 4800 bps, 9600 bps, 19200 bps, 38400 bps, 57600 bps, and 11500 bps are specified as the transmission rates, and of these transmission rates, 2400 bps and 9600 bps are specified as the standard transmission rate (the transmission rates at least one of which needs to be incorporated) while the others are specified as optional transmission rates (transmission rates that can be incorporated arbitrarily).

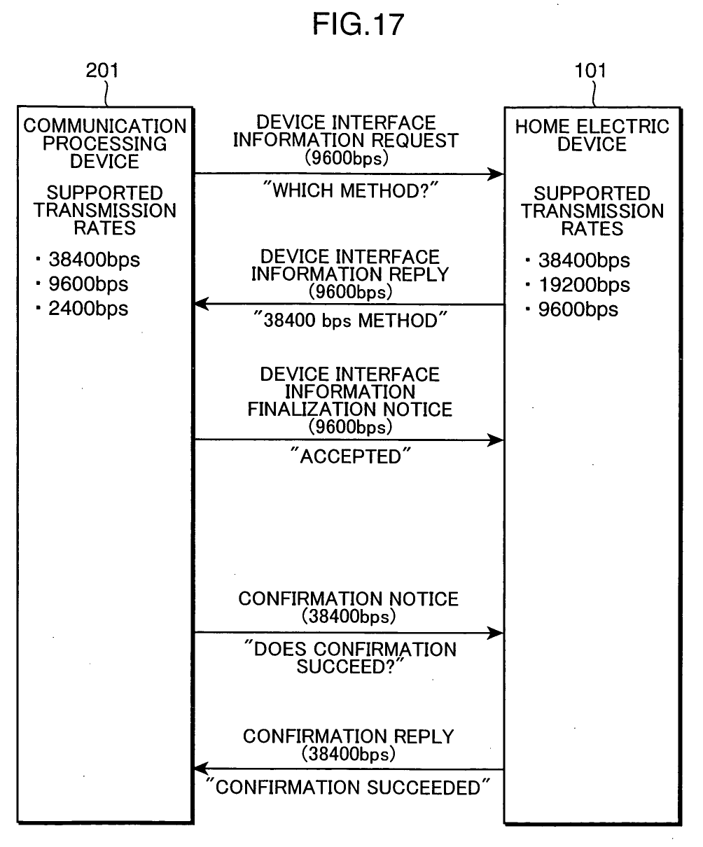

FIG. 17 is a view showing the sequence used to describe one example of the transmission rate negotiation processing between the home electric device 101 and the communication processing device 201 in the initial state. In this case, of the transmission rates specified above, assume that the home electric device 101 supports 9600 bps, 19200 bps, and 38400 bps, and the communication processing device 201 supports 2400 bps, 9600 bps, and 38400 bps.

Initially, when the power supply of the home electric device 101 is switched ON after the communication processing apparatus 201 is connected to the home electric device 101 for the first time, the line control portion 43 in the communication processing device 201 detects the start of the connection, and notifies the telegram processing portion 42 of the connection to the home electric device 101 via the transmission rate setting portion 44.

As is shown in FIG. 17, the communication processing device 201 is triggered by this notice, and sends a device interface information request inquiring about which bps method the home electric device 101 adopts to the home electric device 101 at 9600 bps. The home electric device 101 sends back a device interface information reply informing the adoption of the 38400 bps method, which is its own highest rate, to the communication processing device 201 at 9600 bps. In this case, because the communication processing device 201 is able to make communications using the 38400 bps method, it sends back a device interface information finalization notice informing the acceptance to the home electric device 101 at 9600 bps.

Subsequently, the communication processing device 201 sends a confirmation notice inquiring about whether a confirmation succeeded to the home electric device 101 at 38400 bps. The home electric device 101 sends back a confirmation reply informing the success of the confirmation to the communication processing device 201 at 38400 bps. In this instance, the transmission rate setting portion 34 stores the success of the communication at 38400 bps in the transmission rate storage portion 35. The communication negotiation processing between the home electric device 101 and the communication processing device 201 can be performed in this manner.

However, even when the home electric device and the communication processing device support high transmission rates, both become unable to support high transmission rates when their highest rates differ because these are goods of different manufacturers or for any other reason. For example, when the home electric device 101 supports 9600 bps, 19200 bps, and 38400 bps, whereas the communication processing device 201 supports 2400 bps, 9600 bps, and 19200 bps, a problem as follows will occur.

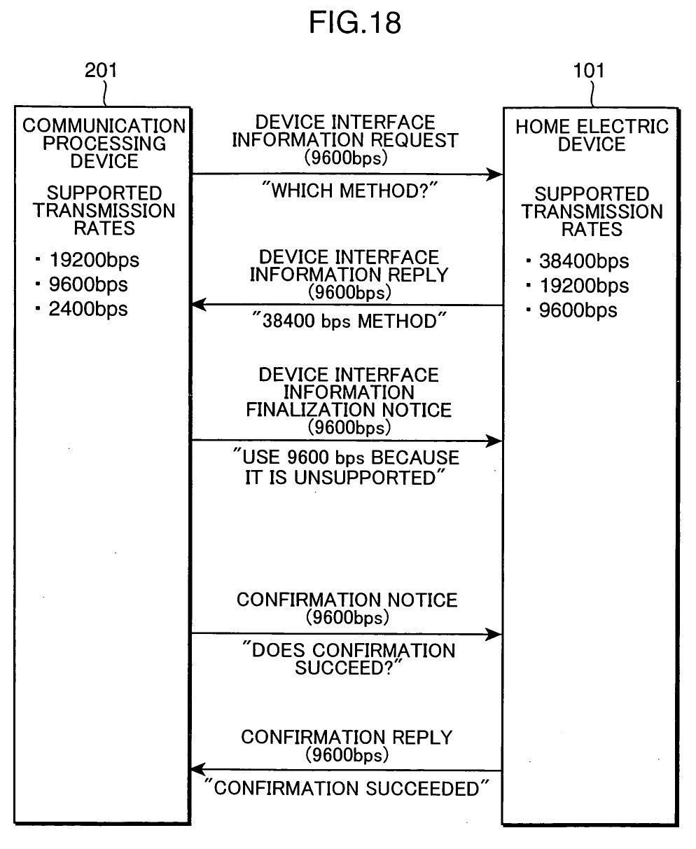

FIG. 18 is a view showing the sequence used to describe another example of the transmission rate negotiation processing between the home electric device 101 and the communication processing device 201 in the initial state. As is shown in FIG. 18, when the communication negotiation processing is performed in the same manner as above, because the communication processing device 201 does not support 38400 bps, which is the highest transmission rate of the home electric device 101, it sends a device interface information finalization notice informing that the transmission rate is set to 9600 bps, which is the standard transmission rate, to the home electric device 101 at 9600 bps.

Subsequently, the communication processing device 201 sends a confirmation notice inquiring about whether the confirmation succeeded to the home electric device 101 at 9600 bps. The home electric device 101 then sends back the confirmation reply informing a success of the confirmation to the communication processing device 201 at 9600 bps. In this instance, the transmission rate setting portion 34 stores a failure of the communication at 38400 bps in the transmission rate storage portion 35. As has been described, communications are made at 9600 bps even when both the home electric device 101 and the communication processing device 201 support 19200 bps, which is higher than 9600 bps.

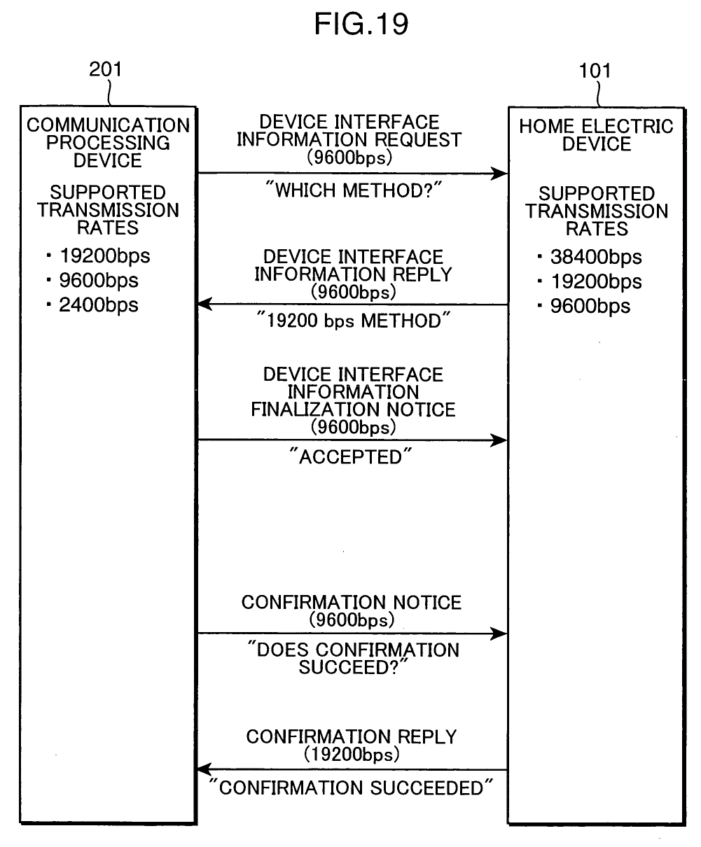

Hence, in this embodiment, the negotiation processing is performed thereafter on the basis of the last transmission rate and the failure/success of last communication stored in the transmission rate storage portion 35 as described above. FIG. 19 is a view showing the sequence used to describe one example of the transmission rate negotiation processing between the home electric device 101 and the communication processing device 201 when the last transmission rate and the failure/success of last communication are stored in the transmission rate storage portion 35.

As is shown in FIG. 19, when the home electric device 101 and the communication processing device 201 are connected to each other, and power is supplied to the communication processing device 201 from the home electric device 101, the data delivery portion 41 sends a device interface information request inquiring about which bps method the home electric device 101 adopts to the home electric device 101 at 9600 bps. In this instance, when the failure of communications at 38400 bps in the last time is stored in the transmission rate storage portion 35, the home electric device 101 sends back a device interface information reply informing the 19200 bps method, which is the next lower transmission rate, to the communication processing device 201 at 9600 bps.

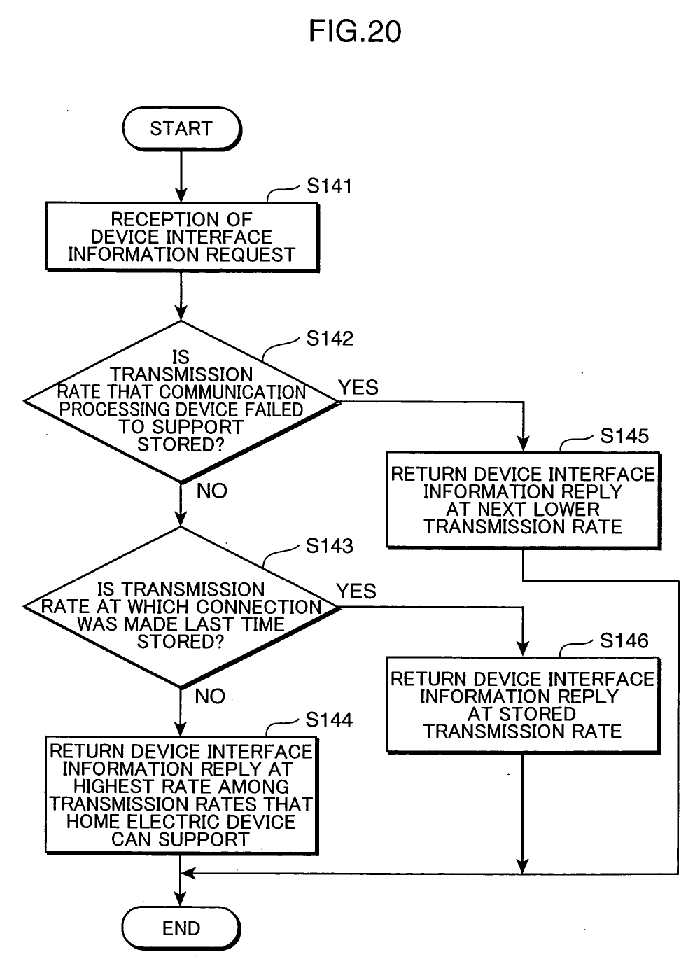

FIG. 20 is a flowchart detailing the device interface information reply sending processing by the home electric device 101 shown in FIG. 12. As is shown in FIG. 20, the telegram processing portion 32 receives the device interface information request from the data delivery portion 31, and makes a request to the transmission rate setting portion 34 to set the transmission rate (S141). Subsequently, the transmission rate setting portion 34 refers to the transmission rate storage portion 35 to judge whether the transmission rate that the communication processing device 201 failed to support last time is stored (S142). When the transmission rate that the communication processing device 201 failed to support last time is stored, the transmission rate setting portion 34 sets the transmission rate to the next lower transmission rate than the stored transmission rate in the line control portion 33, and directs the telegram processing portion 32 to send back a device interface information reply to specify the next lower transmission rate. The telegram processing portion 32 then sends the device interface information reply specifying the next lower transmission rate to the communication processing device 201 from the data delivery portion 31 (S145). For example, when the failure of communications at 38400 bps is stored in the transmission rate storage portion 35, the device interface information reply specifying 19200 bps is sent back.

On the other hand, when the transmission rate that the communication processing 201 failed to support last time is not stored, the transmission rate setting portion 34 refers to the transmission rate storage portion 35 to judge whether the transmission rate at which the connection was established last time is stored (S143). When the transmission rate at which the connection was established last time is stored, the transmission rate setting portion 34 sets the stored transmission rate in the line control portion 33, and directs the telegram processing portion 32 to send back a device interface information reply specifying the stored transmission rate. The telegram processing portion 32 then sends the device interface information reply specifying the stored transmission rate to the communication processing device 201 from the data delivery portion 31 (S146). For example, when the establishment of the connection at 19200 bps is stored in the transmission rate storage portion 35, the device interface information reply specifying 19200 bps is sent back.

On the other hand, when the transmission rate at which the connection was established last time is not stored, the transmission rate setting portion 34 sets the highest transmission rate among those that the home electric device 101 can support in the line control portion 33, and directs the telegram processing portion 32 to send back a device interface information reply specifying the highest transmission rate. The telegram processing portion 32 then sends the device interface information reply specifying the highest transmission rate to the communication processing device 201 from the data delivery portion 31 (S144). For example, when 38400 bps is the highest transmission rate, the device interface information reply specifying 38400 bps is sent back.

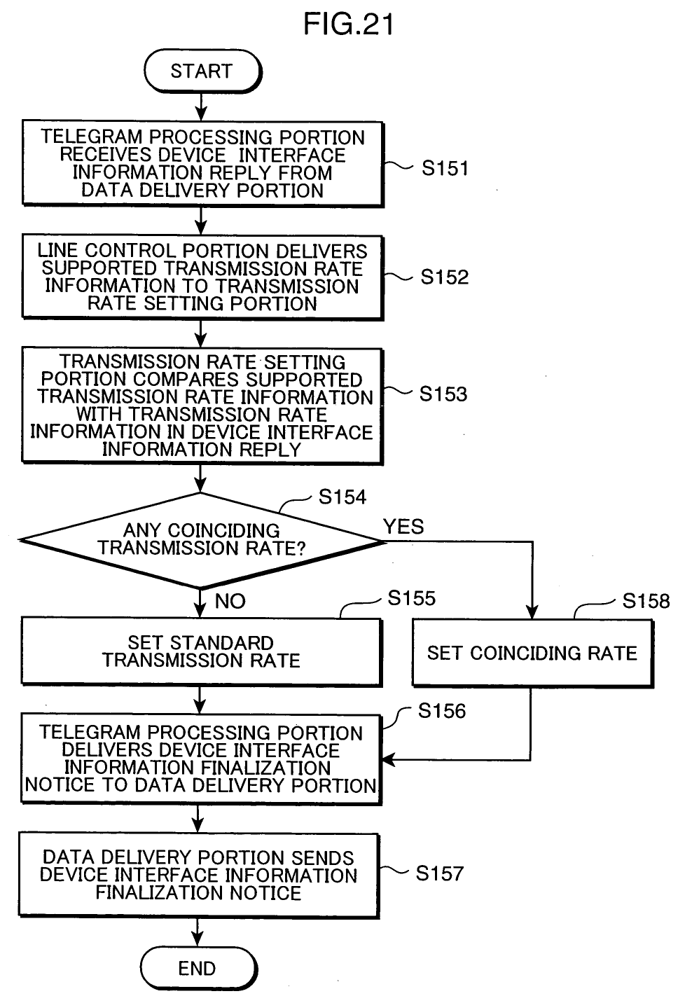

Upon receipt of the device interface information reply sent by the processing described above, the communication processing device 201 sends a device interface information finalization notice to the home electric device 101 in the manner as follows. FIG. 21 is a flowchart detailing the device interface information finalization notice sending processing by the communication processing device 201 shown in FIG. 12.

As is shown in FIG. 21, the telegram processing portion 42 receives the device interface information reply specifying the transmission rate from the data delivery portion 41 (S151). Subsequently, the line control portion 43 outputs the supported transmission rate information indicating transmission rates that the communication processing device 201 can support to the transmission rate setting portion 44 (S152). Subsequently, the transmission rate setting portion 44 compares plural transmission rates specified by the supported transmission rate information with the transmission rates specified by the transmission rate information in the device interface information reply (S153), and judges whether there is a transmission rate that coincides with the transmission rate in the device interface information reply among the transmission rates in the supported transmission rate information from the comparison result (S154).

When the coinciding transmission rate is absent, because the communication processing device 201 does not support the transmission rate specified by the device interface information reply, the transmission rate setting portion 44 sets the standard transmission rate, and notifies the telegram processing portion 42 of the use of the standard transmission rate. The telegram processing portion 42 then generates a device interface information finalization notice to inform that the standard transmission rate is set because the communication processing device 201 does not support the specified transmission rate (S155). On the other hand, when the coinciding transmission rate is present, the transmission rate setting portion 44 sets the coinciding transmission rate, and notifies the telegram processing portion 42 of the use of the transmission rate in the device interface information reply. The telegram processing portion 42 thus generates a device interface information finalization notice to inform the acceptance (S158).

Subsequently, the telegram processing portion 42 outputs the device interface information finalization notice thus generated to the data delivery portion 41 (S156), and the data delivery portion 41 sends the device interface information finalization notice informing any one of the determined transmission rates to the home electric device 101 at the standard transmission rate (S157).

Referring to FIG. 19 again, the communication processing device 201 then sends a confirmation notice inquiring about whether a confirmation succeeded to the home electric device 101 at the transmission rate determined by the processing as above. The home electric device 101 then sends back a confirmation reply informing the success of the confirmation to the communication processing device 201 at the transmission rate determined by the processing as above. For example, the confirmation notice and the confirmation reply are sent and received at 19200 bps, and even when the highest rates are different, it is possible to make communications thereafter at a transmission rate higher than the standard transmission rate.

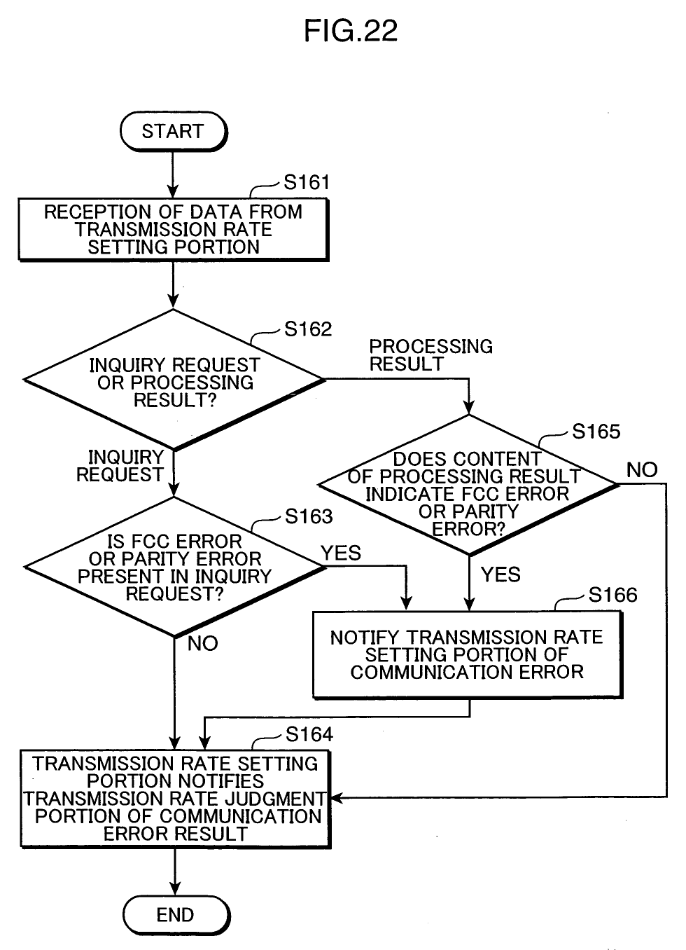

After the communications between the home electric device 101 and the communication processing device 201 are enabled by performing the transmission rate negotiation processing in the initial state as described above, the communication processing device 201 performs communication error detection processing. FIG. 22 is a flowchart detailing the communication error detection processing by the communication processing device 201 shown in FIG. 12.

The normally OFF home electric device, the always ON home electric device, and the stand-by home electric device are able to communicate with the communication processing device 201 when the power supply is in the ON state or the stand-by state, and are not able to communicate with the communication processing device 201 when the power supply is in the OFF state. Hence, for the normally OFF home electric device, a communication error is detected for a specific period (for example, the entire period) from a time at which the power supply is switched ON to a time at which the power supply is switched OFF, and a value obtained by dividing the number of errors occurred during this period by the number of sending and receiving operations is calculated as the communication error ratio. For the always ON home electric device, the communication error is detected for every specific period (for example, one hour), and a value obtained by dividing the number of errors occurred during this period by the operation time (or the number of sending and receiving operations) is calculated as the communication error. For the stand-by home electric device, the communication error is detected for a specific period (for example, the entire period) from a time at which the power supply is switched ON to a time at which the power supply is switched to the stand-by state, and a value obtained by dividing the number of errors occurred during this period by the number of sending and receiving operations is calculated as the communication error.

In each of the measuring periods, as is shown in FIG. 22, the error detection portion 46 receives data outputted from the telegram processing portion 42 via the transmission rate setting portion 44 (S161), and judges whether the data is an inquiry request or a processing result (S162). When the data is an inquiry request, the error detection portion 46 judges whether an FCC error or a parity error is present in the inquiry request (S163). When the FCC error or the parity error is present in the inquiry request, the error detection portion 46 notifies the transmission rate setting portion 44 of a communication error (S166). On the other hand, when the data is the processing result, the error detection portion 46 judges whether an FCC error or a parity error is present in the processing result (S165). When the FCC error or the parity error is present in the processing result, the detection portion 46 notifies the transmission rate setting portion 44 of a communication error (S166). Subsequently, the transmission rate setting portion 44 notifies the home electric type identification portion 47 of the communication error result, and the home electric type identification portion 47 notifies any one of the normally OFF transmission judgment portion 50, the always ON transmission rate judgment portion 51, and the stand-by transmission rate judgment portion 52 of the communication error result depending on the home electric type of the home electric device 101.

Subsequently, of the normally OFF transmission judgment portion 50, the always ON transmission rate judgment portion 51, and the stand-by transmission rate judgment portion 52, the judgment portion that has received the notice saves the communication error result during its own measuring period in any one of the corresponding communication error ratio portion storage portions 53 through 55 cumulatively. When the measuring period ends, the judgment portion calculates the latest communication error ratio by reading out the communication error result from any one of the corresponding communication error ratio storage portions 53 through 55. In this manner, the communication processing device 201 is able to obtain the communication error ratio depending on the home electric type of the home electric device 101.

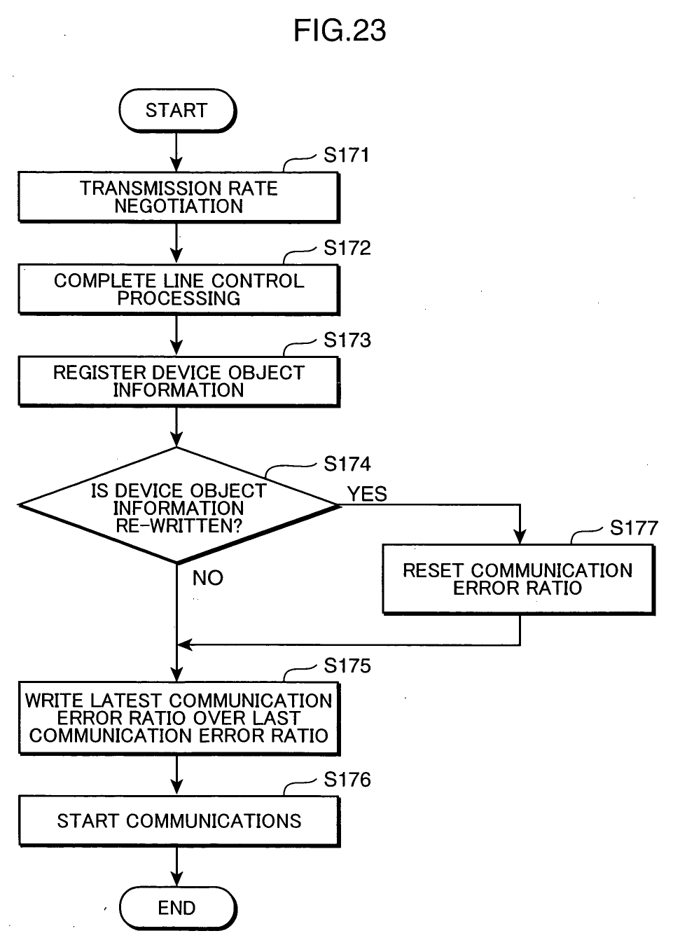

Communication error ratio reset processing to reset the communication error ratio calculated as described above will now be described. FIG. 23 is a flowchart detailing the communication error reset processing by the communication processing device 201 shown in FIG. 12.

As is shown in FIG. 23, when the power supply of the home electric device 101 is switched ON from OFF, the communication processing device 201 is triggered by this switching and starts to perform the transmission rate negotiation processing with the home electric device 101 (S171), and completes the line control processing (S172). Subsequently, the communication processing device 201 receives the device object information from the home electric device 101. The home electric type identification portion 47 then identifies the home electric type of the home electric device 101 from the received device object information of the home electric device 101, and registers the identified device object information (S173). Subsequently, the home electric type identification portion 47 judges whether the registered device object information is different from the device object information registered last time, that is, whether the device object information has been re-written (S174).

When the device object information has been re-written, the home electric type identification portion 47 directs any one of the normally OFF transmission judgment portion 50, the always ON transmission rate judgment portion 51, and the stand-by transmission rate judgment portion 52 to reset the communication error ratios depending on the home electric type of the home electric device 101. The corresponding transmission rate judgment portion thus resets the last communication error ratio and the latest communication error ratio stored in the connected-communication error ratio storage portion (S177).

Subsequently, the home electric type identification portion 47 directs any one of the normally OFF transmission judgment portion 50, the always ON transmission rate judgment portion 51, and the stand-by transmission rate judgment portion 52 to store the latest communication error ratio as the last communication error ratio depending on the home electric type of the home electric device 101. The corresponding transmission rate judgment portion thus writes the latest communication error ratio over the last communication error ratio in the connected-communication error ratio storage portion (S175). Subsequently, the communication processing device 201 starts communications with the home electric device 101, and calculates the communication error ratio by performing the communication error processing detailed in FIG. 22 (S176).

When the power supply of the home electric device is switched ON from OFF and the home electric device that was connected last time is connected, the processing described above makes it possible to store the latest communication error ratio as the last communication error ratio, so that the communication error ratios of communications thereafter can be calculated as the latest communication error ratio. In addition, when the power supply of the home electric device is switched ON from OFF and a new home electric device is connected, the communication error ratio is reset. It is thus possible to prevent the transmission rate negotiation processing described below from being performed on the new home electric device using the communication error ratio of the home electric device that was connected before.

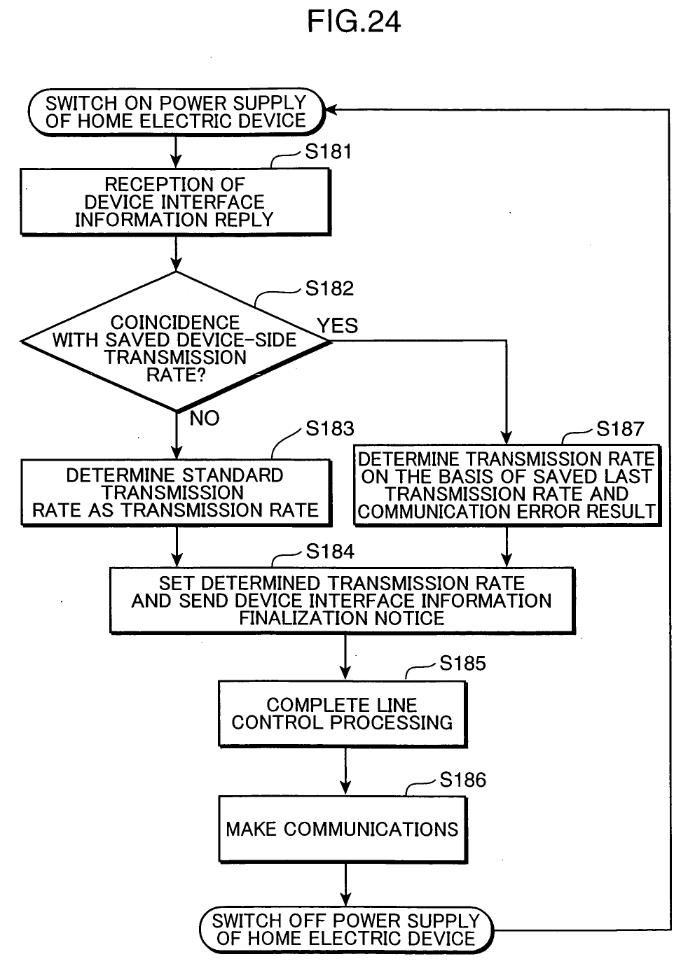

Transmission rate re-negotiation processing to set the transmission rate again depending on the home electric type of the home electric device after the transmission rate is set as described above will now be described. FIG. 24 is a flowchart detailing the transmission rate re-negotiation processing by the communication processing device 201 shown in FIG. 12 for the normally OFF home electric device.

In a case where the home electric device 101 is the normally OFF home electric device, as is shown in FIG. 24, when the power supply of the home electric device 101 is switched to the ON state from the OFF state, the communication processing device 201 is triggered by this switching, and sends a device interface information request to the home electric device 101, after which it receives a device interface information reply specifying the transmission rate of the home electric device 101 from the home electric device 101 (S181). Subsequently, the transmission rate setting portion 44 judges whether any of the transmission rates on the device side saved in the device-side transmission rate table 45 coincides with the transmission rate informed by the device interface information reply (S182).

When the transmission rates do not coincide, the transmission rate setting portions 44 determines the standard transmission rate as the transmission rate (S183). On the other hand, when the transmission rates coincide, the transmission rate setting portion 44 makes an inquiry to the normally OFF transmission rate judgment portion 50 via the home electric type identification portion 47 about whether the transmission rate should be changed. In this instance, the normally OFF transmission rate judgment portion 50 calculates the latest communication error ratio, and determines whether the transmission rate should be changed on the basis of the latest communication error ratio thus calculated and the last communication error ratio stored in the communication error ratio storage portion 53, after which it notifies the transmission rate setting portion 44 of the result via the home electric type identification portion 47. The transmission rate setting portion 44 thus determines the transmission rate on the basis of the communication error result from the normally OFF transmission rate judgment portion 50 and the last transmission rate (the transmission rate currently set at the point in time at which the latest communication error ratio is measured) saved in the device-side transmission rate table 45 (S187).

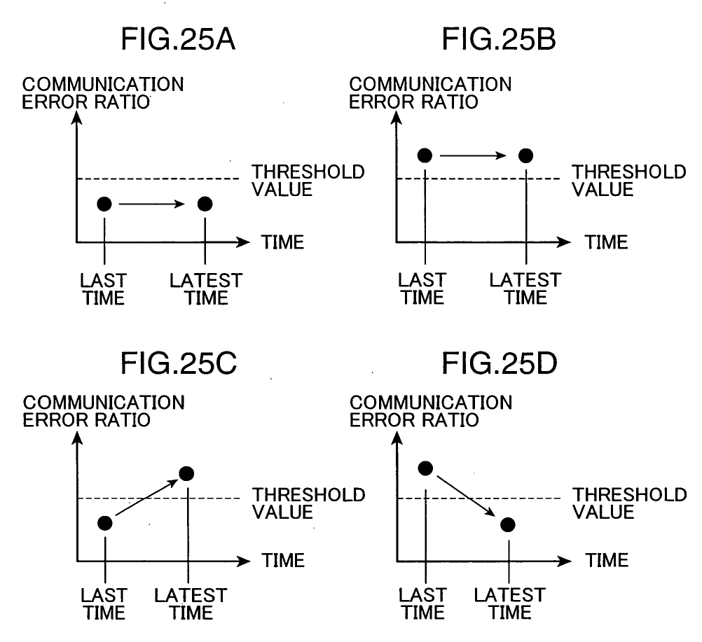

A method for determining the transmission rate on the basis of the last communication error ratio (of the measured communication error ratios, the communication error ratio measured immediately before the most recent communication error ratio) and the latest communication error ratio (the most recent communication error ratio among the measured communication error ratios) will now be described. FIGS. 25A to 25D are views used to describe the method for determining the transmission rate on the basis of the last communication error ratio and the latest transmission rate.

As is shown in FIG. 25A, when both the last communication error ratio and the latest communication error ratio are equal to or lower than the specific threshold value pre-stored in the normally OFF transmission rate judgment portion 50, the normally OFF transmission rate judgment portion 50 directs the transmission rate setting portion 44 to increase the transmission rate to the next higher transmission rate. The transmission rate setting portion 44 thus determines the transmission rate next higher than the last transmission rate among the plural transmission rates stored in the device-side transmission rate table 45 as the transmission rate to be used.

On the other hand, as is shown in FIG. 25B, when both the last communication error ratio and the latest communication error ratio are higher than the threshold value, the normally OFF transmission rate judgment portion 50 directs the transmission rate setting portion 44 to decrease the transmission rate to the next lower transmission rate. The transmission rate setting portion 44 thus determines the transmission rate next lower than the last transmission rate among the transmission rates stored in the device-side transmission table 45 as the transmission rate to be used.

As are shown respectively in FIGS. 25C and 25D, when the last communication error ratio is equal to or lower than the threshold value and the latest communication error ratio is higher than the threshold value, and when the last communication error ratio is higher than the threshold value and the latest communication error ratio is equal to or lower than the threshold value, that is, when the communication error temporarily changes, the normally OFF transmission rate judgment portion 50 directs the transmission rate setting portion 44 to maintain the transmission rate. The transmission rate setting portion 44 thus refers to the device-side transmission rate table 45 and determines the last transmission rate as the transmission rate to be used.

With reference to FIG. 24 again, the transmission rate setting portion 44 sets the determined transmission rate to the telegram processing portion 42. The telegram processing portion 42 then generates a device interface information finalization notice informing the use of the set transmission rate. The data delivery portion 41 sends the device interface information finalization notice containing information about the set transmission rate to the home electric device 101 (S184). Subsequently, the communication processing device 201 completes the line control processing with the home electric device 101 to confirm communications at the informed transmission rate set by the transmission setting portion 44 (S185). In this instance, the transmission rate setting portion 44 directs the normally OFF transmission rate judgment portion 50 to store the latest communication error ratio in the communication error ratio storage portion 53 as the last error ratio.

Thereafter, the communication processing device 201 makes normal communications with the home electric device 101 at the transmission rate determined as described above (S186). In this instance, the communication processing device 201 performs the communication error detection processing described above in parallel, and is therefore able to calculate the communication error ratio from the time at which the power supply was switched ON to the time at which the power supply is switched OFF. When the power supply of the home electric device 101 is switched OFF later, the processing is suspended until the power is switched ON again. By repeating the processing as above, it is possible to set a transmission rate that best suits the normally OFF home electric device according to the history of the communication error ratios in the past.

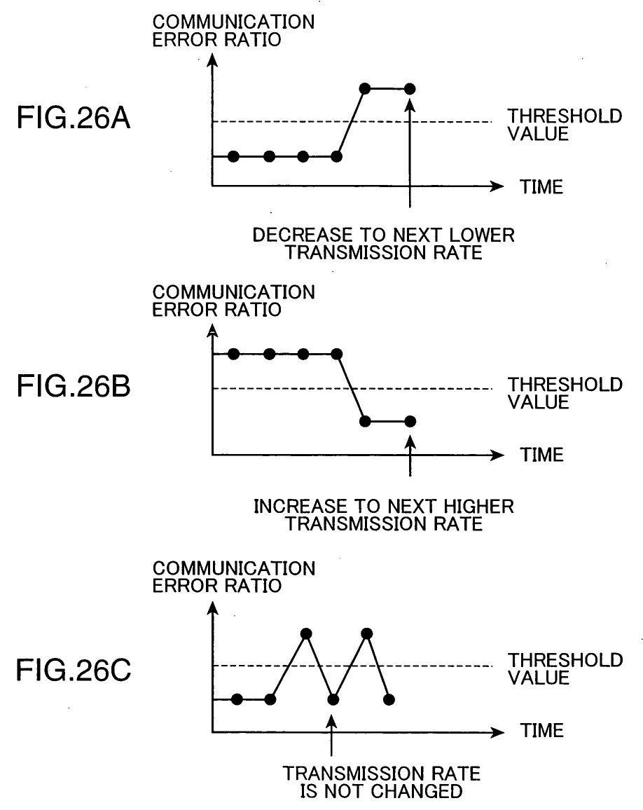

FIGS. 26A to 26C are views used to describe a manner in which the transmission rate is determined in response to one example of a change of the transmission rate. In a case shown in FIG. 26A, the communication error ratio remains equal to or lower than the threshold value, and when the communication error ratio later increases once to be higher than the threshold value, the transmission rate is not changed; however, when the communication error ratio increases twice in succession to be higher than the threshold value, the transmission rate is changed to the transmission rate next lower than the last transmission rate. Also, in an example shown in FIG. 26B, the communication error ratio remains higher than the threshold value, and when the communication error ratio later decreases once to be equal to or lower than the threshold value, the transmission rate is not changed; however, when the communication error ratio decreases twice in succession to be equal to or lower than the threshold value, the transmission rate is changed to the transmission rate next higher than the last transmission rate. Further, in an example shown in FIG. 26C, when the communication error ratio increases and decreases alternately across the threshold value, the transmission rate is not changed. When the communication error ratio changes temporarily in this manner, the transmission rate is not changed. It is thus possible to set the transmission rate that best suits the network home electric device.

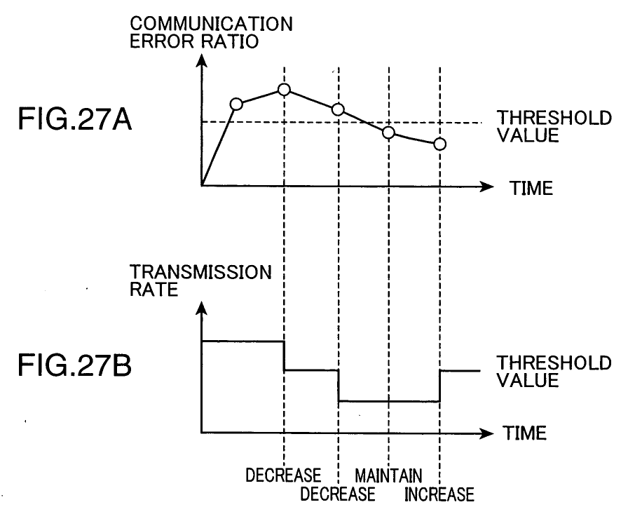

FIGS. 27A and 27B are views showing one example of a change of the communication error ratio and a change of the transmission rate. In an example shown in FIG. 27A and 27B, when the communication error ratio increases twice in succession to be higher than the threshold value, the transmission rate is changed to the transmission rate next lower than the last transmission rate. When the communication error ratio is later maintained to be higher than the threshold value, the transmission rate is changed again to the next lower transmission rate. When the communication error ratio later decreases twice in succession to be equal to or lower than the threshold value, the transmission rate is changed to the next higher transmission rate. In this manner, it is possible to change the transmission rate successively in response to a change of the communication error ratio to best suit the network home electric device.

In this embodiment, the transmission rate is changed in reference to a state where the communication error ratio has changed twice in succession; however, the invention is not limited to this example. By taking the characteristic and the use condition of the home electric device into account, the transmission rate may be changed in reference to a state where the communication error ratio has changed a predetermined number of times not less than three times in succession or in a state where the communication error ratio has changed in a specific pattern three times or more. In addition, the method for determining the transmission rate on the basis of the last communication error ratio and the latest communication error ratio can be used as well for the always ON home electric device and the stand-by home electric device described below.

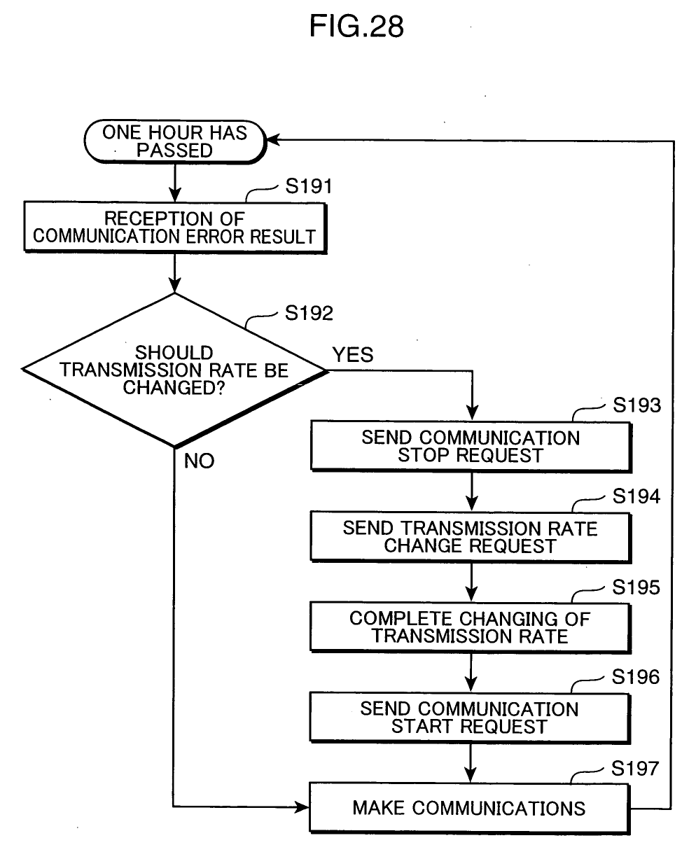

FIG. 28 is a flowchart detailing the transmission rate negotiation processing for the always ON home electric device by the communication processing device 201 shown in FIG. 12.

When the home electric device 101 is the always ON home electric device, as is shown in FIG. 28, the transmission rate setting portion 44 performs a time keeping operation using an internal timer, and when a specific time, for example, one hour, has passed, it makes an inquiry to the always ON transmission rate judgment portion 51 via the home electric type identification portion 47 about whether the transmission rate should be changed. As with the normally OFF transmission rate judgment portion 50 described above, the always ON transmission rate judgment portion 51 calculates the latest communication error ratio, and determines whether the transmission rate should be changed on the basis of the latest communication error ratio thus calculated and the last communication error ratio stored in the communication error ratio storage portion 54, after which it notifies the transmission rate setting portion 44 of the result via the home electric type identification portion 47. The transmission rate setting portion 44 thus receives the communication error result (S191).

Subsequently, the transmission rate setting portion 44 judges whether the transmission rate should be changed according to the communication error result from the always ON transmission judgment portion 51 (S192). When the transmission rate should not be changed, the communication processing device 201 makes normal communications with the home electric device 101 while keeping the transmission rate unchanged (S197).

On the other hand, when the transmission rate should be changed, the transmission rate setting portion 44 notifies the telegram processing portion 42 of an instruction to generate a communication stop request to stop communications with the outside via the network 300. The telegram processing portion 42 thus generates the communication stop request to stop communications with the outside and outputs the communication stop request to the communication interface 6 via the telegram conversion portion 5. The communication interface 6 thus stops communications with the outside via the network 300 (S193).

Subsequently, the transmission rate setting portion 44 follows the method for determining the transmission rate on the basis of the last communication error ratio and the latest transmission rate shown in FIG. 25, and thereby determines the transmission rate on the basis of the communication error result from the always ON transmission rate judgment portion 51 and the last transmission rate saved in the device-side transmission rate table 45, after which it notifies the telegram processing portion 42 of the result. The telegram processing portion 42 then generates a transmission rate change request instructing to use the determined transmission rate, and the data delivery portion 41 sends the transmission rate change request containing the transmission rate to be used to the home electric device 101 (S194).

Subsequently, the communication processing device 201 completes the transmission rate change processing with the home electric device 101 to confirm communications at the informed transmission rate (S195). In this instance, the transmission rate setting portion 44 directs the always ON transmission rate judgment portion 51 to store the latest communication error ratio in the communication error ratio storage portion 54 as the last error ratio.

Subsequently, the transmission rate setting portion 44 notifies the telegram proceeding portion 42 of an instruction to generate a communication start request to start communications with the outside via the network 300. The telegram processing portion 42 thus generates a communication start request instructing to start communications with the outside, and outputs the communication start request to the communication interface 6 via the telegram conversion portion 5. The communication interface 6 thus starts communications with the outside via the network 300 (S196).

Thereafter, the communication processing device 201 makes normal communications with the home electric device 101 at the transmission rate changed as described above (S197). In this instance, the communication processing device 201 performs the communication error detection processing described above in parallel, and is therefore able to calculate the communication error ratio for every hour. The processing described above is repeated thereafter each time one hour has passed. It is thus possible to set the transmission rate that best suits the always OFF home electric device according to the history of the communication error ratios in the past.

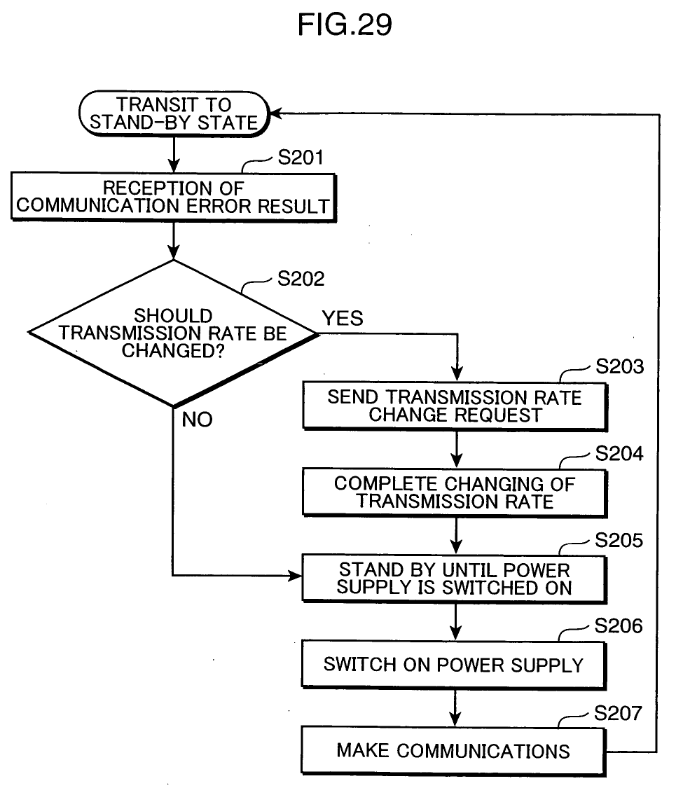

FIG. 29 is a flowchart detailing the transmission rate negotiation processing by the communication processing device 201 shown in FIG. 12 for the stand-by home electric device. When the home electric device 101 is the stand-by home electric device, as is shown in FIG. 29, as the power supply of the home electric device 101 is switched to the stand-by state from the ON state, the transmission rate setting portion 44 makes an inquiry to the stand-by transmission rate judgment portion 52 via the home electric type identification portion 47 about whether the transmission rate should be changed. As with the normally OFF transmission rate judgment portion 50 described above, the stand-by transmission rate judgment portion 52 calculates the latest communication error ratio, and determines whether the transmission rate should be changed on the basis of the latest communication error ratio thus calculated and the last communication error ratio stored in the communication error ratio storage portion 55, after which it notifies the transmission rate setting portion 44 of the result via the home electric type identification portion 47. The transmission rate setting portion 44 thus receives the communication error result (S201).

Subsequently, the transmission rate setting portion 44 follows the communication error result from the stand-by transmission rate judgment portion 52, and judges whether the transmission rate should be changed (S202). When the transmission rate should not be changed, the communication processing device 201 stands by until the power supply of the home electric device 101 is switched to the ON state while keeping the transmission rate unchanged (S205).

On the other hand, when the transmission rate should be changed, the transmission rate setting portion 44 follows the method for determining the transmission rate on the basis of the last communication error ratio and the latest transmission rate shown in FIG. 25, and thereby determines the transmission rate on the basis of the communication error result from the stand-by transmission rate judgment portion 52 and the last transmission rate saved in the device-side transmission rate table 45, after which it notifies the telegram processing portion 42 of the result. The telegram processing portion 42 thus generates a transmission rate change request instructing to use the determined transmission rate. The data delivery portion 41 sends the transmission rate change request containing the information about the transmission rate to be used to the home electric device 101 (S203).

Subsequently, the communication processing device 201 completes the transmission rate change processing with the home electric device 101 to confirm communications at the informed transmission rate (S204). In this instance, the transmission rate setting portion 44 directs the stand-by transmission rate judgment portion 52 to store the latest communication error ratio in the communication error ratio storage portion 55 as the last error ratio.

Subsequently, the communication processing device 201 stands by until the power supply of the home electric device 101 is switched to the ON state (S205). When there is a possibility that the communication processing device 201 makes communications with the outside via the network 300 in the stand-by state, it may be configured in such a manner that processing in S194 shown in FIG. 28 is performed before processing in S203, and processing in S197 shown in FIG. 28 is performed after processing in S204.

Subsequently, when the power supply of the home electric device 101 is switched to the ON state (S206), the communication processing device 201 makes normal communications with the home electric device 101 at the transmission rate that is either maintained or changed as described above (S207). In this instance, the communication processing device 201 performs the communication error detection processing described above in parallel, and is therefore able to calculate the communication error ratio since the power supply is switched ON until the power supply is switched to the stand-by state. When the power supply of the home electric device 101 is switched later to the stand-by state from the ON state, the processing as above is repeated. It is thus possible to set the transmission rate that best suits the stand-by home electric device according to the history of the communication error ratios in the past.

The home electric devices and the communication devices in the respective embodiments above can be combined as desired to construct a home network system. In such a case, the advantages achieved by the configurations of each component can be achieved as well.

### INDUSTRIAL APPLICABILITY

The communication processing device of the invention is able to set an optimal transmission rate in accordance with the communication environment with the home electric device, and is useful as a communication processing device or the like that links the home electric device forming the home network system to the network.

1-25. (canceled)

26. A communication processing device that links a home electric device to a network, characterized by comprising:
a communication portion that sends/receives data to/from the home electric device;
a detection portion that detects a communication error status with the home electric device;
a storage portion that stores the communication error status detected by the detection portion; and
a setting portion that sets a transmission rate with the home electric device on a basis of a last communication error status stored in the storage portion and a latest communication error status detected by the detection portion.

27. The communication processing device according to claim 26, further comprising:
an identification portion that identifies a type of the home electric device as any one of a normally OFF home electric device for which a power supply is switched OFF when not in use and the power supply is switched ON when used, an always ON home electric device that is kept run with a power supply being kept switched ON, and a stand-by home electric device for which a power supply is switched to a stand-by state when not in use and the power supply is switched ON when used,
wherein the setting portion sets the transmission rate with the home electric device on the basis of the last communication error status stored in the storage portion and the latest communication error status detected by the detection portion depending on the type of the home electric device identified by the identification portion.

28. The communication processing device according to claim 27, wherein:
the storage portion includes a normally OFF storage portion that stores the communication error status detected by the detection portion when the home electric device is the normally OFF home electric device; and
the setting portion sets the transmission rate with the home electric device on the basis of the last communication error status stored in the normally OFF storage portion and the latest communication error status detected by the detection portion when the home electric device is the normally OFF home electric device.

29. The communication processing device according to claim 28, wherein:
the detection portion detects a communication error ratio with the normally OFF home electric device from a time at which the power supply is switched ON to a time at which the power supply is switched OFF when the home electric device is the normally OFF home electric device;
the normally OFF storage portion stores the communication error ratio detected by the detection portion when the home electric device is the normally OFF home electric device; and
the setting portion sets the transmission rate with the home electric device on the basis of a last communication error ratio stored in the normally OFF storage portion and a latest communication error ratio detected by the detection portion when the home electric device is the normally OFF home electric device.

30. The communication processing device according to claim 27, wherein:
the storage portion includes an always ON storage portion that stores the communication error status detected by the detection portion when the home electric device is the always ON home electric device; and
the setting portion sets the transmission rate with the home electric device on the basis of the last communication error status stored in the always ON storage portion and the latest communication error status detected by the detection portion when the home electric device is the always ON home electric device.

31. The communication processing device according to claim 30, wherein:
the detection portion detects a communication error ratio with the home electric device for every certain period when the home electric device is the always ON home electric device;
the always ON storage portion stores the communication error ratio detected by the detection portion when the home electric device is the always ON home electric device; and
the setting portion sets the transmission rate with the home electric device on the basis of a last communication error ratio stored in the always ON storage portion and a latest communication error ratio detected by the detection portion when the home electric device is the always ON home electric device.

32. The communication processing device according to claim 27, wherein:
the storage portion includes a stand-by storage portion that stores the communication error status detected by the detection portion when the home electric device is the stand-by home electric device; and
the setting portion sets the transmission rate with the home electric device on the basis of the last communication error status stored in the stand-by storage portion and the latest communication error status detected by the detection portion when the home electric device is the stand-by home electric device.

33. The communication processing device according to claim 32, wherein:
the detection portion detects a communication error ratio with the home electric device for every certain period when the home electric device is the stand-by home electric device;
the always ON storage portion stores the communication error ratio detected by the detection portion when the home electric device is the stand-by home electric device; and
the setting portion sets the transmission rate with the home electric device on the basis of a last communication error ratio stored in the stand-by storage portion and a latest communication error ratio detected by the detection portion when the home electric device is the stand-by home electric device.

34. The communication processing device according to claim 29, wherein:
the setting portion sets a transmission rate lower than a transmission rate at which the latest communication error ratio is detected when both the last communication error ratio stored in the storage portion and the latest communication error ratio detected by the detection portion are equal to or higher than a specific threshold value, and sets a transmission rate higher than the transmission rate at which the latest communication error ratio is detected when both the last communication error ratio stored in the storage portion and the latest communication error ratio detected by the detection portion are lower than the specific threshold value.

35. The communication processing device according to claim 31, wherein:
the setting portion sets a transmission rate lower than a transmission rate at which the latest communication error ratio is detected when both the last communication error ratio stored in the storage portion and the latest communication error ratio detected by the detection portion are equal to or higher than a specific threshold value, and sets a transmission rate higher than the transmission rate at which the latest communication error ratio is detected when both the last communication error ratio stored in the storage portion and the latest communication error ratio detected by the detection portion are lower than the specific threshold value.

36. The communication processing device according to claim 33, wherein:
the setting portion sets a transmission rate lower than a transmission rate at which the latest communication error ratio is detected when both the last communication error ratio stored in the storage portion and the latest communication error ratio detected by the detection portion are equal to or higher than a specific threshold value, and sets a transmission rate higher than the transmission rate at which the latest communication error ratio is detected when both the last communication error ratio stored in the storage portion and the latest communication error ratio detected by the detection portion are lower than the specific threshold value.

37. A computer-readable recording medium in which a communication program is recorded, characterized by causing a microcomputer incorporated in a communication processing device that links a home electric device to a network to function as portions as follows:
a communication portion that sends/receives data to/from the home electric device;
a detection portion that detects a communication error status with the home electric device;
a storage portion that stores the communication error status detected by the detection portion; and
a setting portion that sets a transmission rate with the home electric device on a basis of a last communication error status stored in the storage portion and a latest communication error status detected by the detection portion.

38. A communication processing device that links a home electric device to a network, characterized by comprising:
a communication portion that sends/receives data to/from the home electric device;
a save portion that saves plural transmission rates settable in the communication processing device; and
a setting portion that sets a transmission rate on a basis of plural transmission rates settable in the home electric device and received at the communication portion and the plural transmission rates saved in the save portion,
wherein:
the communication portion sends a transmission rate notice to the home electric device to inform a transmission rate that the setting portion is to set before the setting portion sets the transmission rate;
the setting portion sets the transmission rate when the transmission rate informed by a reply to the transmission rate notice from the home electric device received at the communication portion coincides with the transmission rate to be set; and
the communication portion sends confirmation data to the home electric device to confirm that communications are enabled with the home electric device at the set transmission rate after the setting portion sets the transmission rate.

39. The communication processing device according to claim 38, wherein:
the communication portion sends the confirmation data to the home electric device when a predetermined time has passed since the reply to the transmission rate notice is received from the home electric device.

40. A computer-readable recording medium in which a communication program is recorded, characterized by causing a microcomputer incorporated in a communication processing device that links a home electric device to a network to function as portions as follows:
a communication portion that sends/receives data to/from the home electric device;
a save portion that saves plural transmission rates settable in the communication processing device; and
a setting portion that sets a transmission rate on a basis of plural transmission rates settable in the home electric device and received at the communication portion and the plural transmission rates saved in the save portion,
wherein:
the communication portion sends a transmission rate notice to the home electric device to inform a transmission rate that the setting portion is to set before the setting portion sets the transmission rate;
the setting portion sets the transmission rate when the transmission rate informed by a reply to the transmission rate notice from the home electric device received at the communication portion coincides with the transmission rate to be set; and
the communication portion sends confirmation data to the home electric device to confirm that communications are enabled with the home electric device at the set transmission rate after the setting portion sets the transmission rate.

41. A home electric device that is linked to a network via a communication processing device, characterized by comprising:
a communication portion that sends/receives data to/from the communication processing device;
a storage portion that stores a communication error status with the communication processing device; and
a setting portion that sets a transmission rate with the communication processing device on a basis of communication error statuses in past times stored in the storage portion,
wherein:
the storage portion stores a transmission rate at which communications with the communication processing device failed; and
the setting portion sets a transmission rate lower than the transmission rate at which communications with the communication processing device failed when the transmission rate at which communications with the communication processing device failed is stored in the storage portion.

42. A computer-readable recording medium in which a communication program is recorded, characterized by causing a microcomputer incorporated in a home electric device that is linked to a network via a communication processing device to function as portions as follows:
a communication portion that sends/receives data to/from the communication processing device;
a storage portion that stores a communication error status with the communication processing device; and
a setting portion that sets a transmission rate with the communication processing device on a basis of communication error statuses in past times stored in the storage portion,
wherein:
the storage portion stores a transmission rate at which communications with the communication processing device failed; and
the setting portion sets a transmission rate lower than the transmission rate at which communications with the communication processing device failed when the transmission rate at which communications with the communication processing device failed is stored in the storage portion.

43. A home network system, comprising:
the communication processing device according to claim 26; and
a home electric device that is linked to a network via a communication processing device, characterized by comprising:
a communication portion that sends/receives data to/from the communication processing device;
a storage portion that stores a communication error status with the communication processing device; and
a setting portion that sets a transmission rate with the communication processing device on a basis of communication error statuses in past times stored in the storage portion,
wherein:
the storage portion stores a transmission rate at which communications with the communication processing device failed; and
the setting portion sets a transmission rate lower than the transmission rate at which communications with the communication processing device failed when the transmission rate at which communications with the communication processing device failed is stored in the storage portion.

44. A home network system, comprising:
the communication processing device according to claim 38; and
a home electric device that is linked to a network via a communication processing device, characterized by comprising:
a communication portion that sends/receives data to/from the communication processing device;
a storage portion that stores a communication error status with the communication processing device; and
a setting portion that sets a transmission rate with the communication processing device on a basis of communication error statuses in past times stored in the storage portion,
wherein:
the storage portion stores a transmission rate at which communications with the communication processing device failed; and
the setting portion sets a transmission rate lower than the transmission rate at which communications with the communication processing device failed when the transmission rate at which communications with the communication processing device failed is stored in the storage portion.
